(19) United States
(12) Patent Application Publication
(10) Pub. No.: US 2026/0188594 A1
(43) Pub. Date: Jul. 2, 2026

(54) PASSIVE ELECTRONIC COMPONENT

(71) Applicant: Murata Manufacturing Co., Ltd., Nagaokakyo-shi (JP)

(72) Inventors: Yuta IMAMURA, Nagaokakyo-shi (JP); Masatomi HARADA, Nagaokakyo-shi (JP); Takeshi KAGAWA, Nagaokakyo-shi (JP); Korekiyo ITO, Nagaokakyo-shi (JP); Masaki TSUKIDA, Nagaokakyo-shi (JP)

(21) Appl. No.: 19/551,742

(22) Filed: Feb. 27, 2026

Related U.S. Application Data
(63) Continuation of application No. PCT/JP2024/029565, filed on Aug. 21, 2024.

(30) Foreign Application Priority Data
Sep. 8, 2023 (JP) 2023-146225

(51) Int. Cl. H01G 4/33; H01G 4/012; H01G 4/252

(52) U.S. Cl. CPC H01G 4/33; H01G 4/012; H01G 4/252

(57) ABSTRACT

A passive electronic component that includes a substrate with first and second main surfaces opposed in a first direction; and a capacitor on the first main-surface side. The capacitor has a capacitance-forming portion in which three or more inner electrode layers and dielectric layers are alternately laminated in the first direction. Counting all inner electrode layers from the substrate side in the first direction, layers at odd positions form a first group and layers at even positions form a second group. Nth inner electrode layers define a first group and (N-1)th inner electrode layers define a second group. In plan view from the first direction, a second direction is perpendicular to the average current flow. In a cross-section along the first and second directions, the opposed end portions of the Nth layer lie outward of those of the (N-1)th layer in the second direction.

### CROSS REFERENCE TO RELATED APPLICATIONS

The present application is a continuation of International application No. PCT/JP2024/029565, filed Aug. 21, 2024, which claims priority to Japanese Patent Application No. 2023-146225, filed Sep. 8, 2023, the entire contents of each of which are incorporated herein by reference.

### TECHNICAL FIELD

The present disclosure relates to a passive electronic component.

### BACKGROUND ART

Patent Document 1 discloses a multilayer thin film capacitor in which a plurality of electrodes belonging to one group, a plurality of dielectric layers, and a plurality of electrodes belonging to the other group are alternately laminated on one main surface side of a substrate such that the electrode belonging to the one group and the electrode belonging to the other group are opposed to each other with the dielectric layer interposed between. The multilayer thin film capacitor has a first connection portion in which the plurality of electrodes belonging to the one group are overlapped with each other on one end side of an opposing region in which the electrode belonging to the one group and the electrode belonging to the other group are opposed to each other with the dielectric layer interposed between. The multilayer thin film capacitor has a second connection portion in which the plurality of electrodes belonging to the other group are overlapped with each other on the other end side of the opposing region. A conductor layer for thickness adjustment that reduces a step from the opposing region is further overlapped on each of the first connection portion and the second connection portion.

Patent Document 1: Japanese Unexamined Patent Application Publication No. 2009-21514

### SUMMARY OF THE DISCLOSURE

In the multilayer thin film capacitor described in Patent Document 1, an element body is configured by alternately laminating, on the one main surface side of the substrate, the plurality of electrodes belonging to the one group, the plurality of dielectric layers, and the plurality of electrodes belonging to the other group such that the electrode belonging to the one group and the electrode belonging to the other group are opposed to each other with the dielectric layer interposed therebetween. However, in the multilayer thin film capacitor described in Patent Document 1, for example, in a configuration depicted in FIG. 1 of Patent Document 1, when a voltage is applied to the element body, particularly an electric field generated between the electrode located closest to the substrate in the one group and the electrode located closest to the substrate in the other group is likely to penetrate into the substrate. Thus, in the multilayer thin film capacitor described in Patent Document 1, when a voltage is applied to the element body, power loss in the substrate is likely to occur, and as a result, the quality factor (Q factor) of the multilayer thin film capacitor is likely to decrease.

The present disclosure has been made to solve the above problem, and an object thereof is to provide a passive electronic component capable of suppressing a decrease in the Q factor due to an electric field penetrating into a substrate.

As a first aspect, a passive electronic component of the present disclosure includes: a substrate having a first main surface and a second main surface opposed to each other in a first direction; and a capacitor on a first main surface side of the substrate. The capacitor has a capacitance forming portion in which inner electrode layers and dielectric layers are alternately laminated in the first direction. The capacitance forming portion has three or more of the inner electrode layers. In a case where, when all of the three or more of the inner electrode layers are counted in order from the substrate side in the first direction, a first group to which the inner electrode layers located at odd-numbered positions belong and a second group to which the inner electrode layers located at even-numbered positions belong are defined, and, when all the inner electrode layers are counted in order from the substrate side in the first direction, with N being an odd number of three or more, an Nth inner electrode layer that is located at an Nth position and belongs to the first group and an (N-1)th inner electrode layer that is located at an (N-1)th position and belongs to the second group are defined, and, in plan view from the first direction, a second direction perpendicular to an average direction of a current flowing through the capacitance forming portion when a voltage is applied to the capacitance forming portion is defined, in a cross section taken along the first direction and the second direction, opposed end portions of the Nth inner electrode layer of the first group in the second direction are located on an outer side in the second direction relative to opposed end portions of the (N-1)th inner electrode layer of the second group in the second direction.

As a second aspect, a passive electronic component of the present disclosure includes: a substrate having a first main surface and a second main surface opposed to each other in a first direction; and a capacitor on a first main surface side of the substrate. The capacitor has a capacitance forming portion in which inner electrode layers and dielectric layers are alternately laminated in the first direction. The capacitance forming portion has four or more of the inner electrode layers. In a case where, when all of the four or more of the inner electrode layers are counted in order from the substrate side in the first direction, a first group to which the inner electrode layers located at odd-numbered positions belong and a second group to which the inner electrode layers located at even-numbered positions belong are defined, and, when all the inner electrode layers are counted in order from the substrate side in the first direction, with N being an even number of four or more, an Nth inner electrode layer that is located at an Nth position and belongs to the second group and an (N-1)th inner electrode layer that is located at an (N-1)th position and belongs to the first group are defined, and, in plan view from the first direction, a second direction perpendicular to an average direction of a current flowing through the capacitance forming portion when a voltage is applied to the capacitance forming portion is defined, in a cross section taken along the first direction and the second direction, opposed end portions of the Nth inner electrode layer of the second group in the second direction are located on an outer side in the second direction relative to opposed end portions of the (N-1)th inner electrode layer of the first group in the second direction.

As a third aspect, a passive electronic component of the present disclosure includes: a substrate having a first main surface and a second main surface opposed to each other in a first direction; and a capacitor on a first main surface side of the substrate. The capacitor has a capacitance forming portion in which inner electrode layers and dielectric layers are alternately laminated in the first direction. The capacitance forming portion has three or more of the inner electrode layers. In a case where, when all of the three or more of the inner electrode layers are counted in order from the substrate side in the first direction, a first group to which the inner electrode layers located at odd-numbered positions belong and a second group to which the inner electrode layers located at even-numbered positions belong are defined, in plan view from the first direction, peripheral edges of all the inner electrode layers of the second group are located on an inner side relative to a peripheral edge of a first inner electrode layer located closest to the substrate in the first group.

According to the present disclosure, it is possible to provide the passive electronic component capable of suppressing a decrease in the Q factor due to the electric field penetrating into the substrate.

### BRIEF DESCRIPTION OF THE DRAWINGS

FIG. 1 is a schematic plan view depicting an example of a passive electronic component of embodiment 1 of the present disclosure.

FIG. 2 is a schematic cross-sectional view depicting an example of a cross section taken along line a1-a2 of the passive electronic component depicted in FIG. 1.

FIG. 3 is a schematic cross-sectional view depicting an example of a cross section taken along line b1-b2 of the passive electronic component depicted in FIG. 1 (excluding a first outer electrode).

FIG. 4 is a schematic cross-sectional view depicting a step of preparing a substrate in an example of a manufacturing method for the passive electronic component of embodiment 1 of the present disclosure.

FIG. 5 is a schematic cross-sectional view depicting a step of forming an insulating layer in the example of the manufacturing method for the passive electronic component of embodiment 1 of the present disclosure.

FIG. 6 is a schematic cross-sectional view depicting a step of forming a first inner electrode layer in the example of the manufacturing method for the passive electronic component of embodiment 1 of the present disclosure.

FIG. 7 is a schematic cross-sectional view depicting a step of forming a first dielectric layer in the example of the manufacturing method for the passive electronic component of embodiment 1 of the present disclosure.

FIG. 8 is a schematic cross-sectional view depicting a step of forming a second inner electrode layer in the example of the manufacturing method for the passive electronic component of embodiment 1 of the present disclosure.

FIG. 9 is a schematic cross-sectional view depicting a step of forming a second dielectric layer in the example of the manufacturing method for the passive electronic component of embodiment 1 of the present disclosure.

FIG. 10 is a schematic cross-sectional view depicting a step of forming a third inner electrode layer in the example of the manufacturing method for the passive electronic component of embodiment 1 of the present disclosure.

FIG. 11 is a schematic cross-sectional view depicting a step of forming a third dielectric layer in the example of the manufacturing method for the passive electronic component of embodiment 1 of the present disclosure.

FIG. 12 is a schematic cross-sectional view depicting a step of forming a fourth inner electrode layer in the example of the manufacturing method for the passive electronic component of embodiment 1 of the present disclosure.

FIG. 13 is a schematic cross-sectional view depicting a step of forming a fourth dielectric layer in the example of the manufacturing method for the passive electronic component of embodiment 1 of the present disclosure.

FIG. 14 is a schematic cross-sectional view depicting a step of forming a fifth inner electrode layer in the example of the manufacturing method for the passive electronic component of embodiment 1 of the present disclosure.

FIG. 15 is a schematic cross-sectional view depicting a step of forming a moisture-resistant protective layer in the example of the manufacturing method for the passive electronic component of embodiment 1 of the present disclosure.

FIG. 16 is a schematic cross-sectional view depicting a step of forming a resin protective layer in the example of the manufacturing method for the passive electronic component of embodiment 1 of the present disclosure.

FIG. 17 is a schematic cross-sectional view depicting a step of forming the first outer electrode and a second outer electrode in the example of the manufacturing method for the passive electronic component of embodiment 1 of the present disclosure.

FIG. 18 is a schematic cross-sectional view depicting the step of forming the first outer electrode and the second outer electrode in the example of the manufacturing method for the passive electronic component of embodiment 1 of the present disclosure.

FIG. 19 is a schematic cross-sectional view depicting the step of forming the first outer electrode and the second outer electrode in the example of the manufacturing method for the passive electronic component of embodiment 1 of the present disclosure.

FIG. 20 is a schematic plan view depicting another example of the passive electronic component of embodiment 1 of the present disclosure.

FIG. 21 is a schematic cross-sectional view depicting an example of a cross section taken along line b3-b4 of the passive electronic component depicted in FIG. 20 (excluding the first outer electrode).

FIG. 22 is a schematic cross-sectional view depicting another example of the cross section taken along line b3-b4 of the passive electronic component depicted in FIG. 20 (excluding the first outer electrode).

FIG. 23 is a schematic plan view depicting still another example of the passive electronic component of embodiment 1 of the present disclosure.

FIG. 24 is a schematic cross-sectional view depicting an example of a cross section taken along line b5-b6 of the passive electronic component depicted in FIG. 23 (excluding the first outer electrode).

FIG. 25 is a schematic cross-sectional view depicting another example of the cross section taken along line b5-b6 of the passive electronic component depicted in FIG. 23 (excluding the first outer electrode).

FIG. 26 is a schematic plan view depicting an example of a passive electronic component of embodiment 2 of the present disclosure.

FIG. 27 is a schematic cross-sectional view depicting an example of a cross section taken along line c1-c2 of the passive electronic component depicted in FIG. 26.

FIG. 28 is a schematic cross-sectional view depicting an example of a cross section taken along line d1-d2 of the passive electronic component depicted in FIG. 26 (excluding the first outer electrode).

FIG. 29 is a schematic plan view depicting another example of the passive electronic component of embodiment 2 of the present disclosure.

FIG. 30 is a schematic cross-sectional view depicting an example of a cross section taken along line d3-d4 of the passive electronic component depicted in FIG. 29 (excluding the first outer electrode).

FIG. 31 is a schematic cross-sectional view depicting another example of the cross section taken along line d3-d4 of the passive electronic component depicted in FIG. 29 (excluding the first outer electrode).

FIG. 32 is a schematic plan view depicting still another example of the passive electronic component of embodiment 2 of the present disclosure.

FIG. 33 is a schematic cross-sectional view depicting an example of a cross section taken along line d5-d6 of the passive electronic component depicted in FIG. 32 (excluding the first outer electrode).

FIG. 34 is a schematic cross-sectional view depicting another example of the cross section taken along line d5-d6 of the passive electronic component depicted in FIG. 32 (excluding the first outer electrode).

FIG. 35 is a schematic plan view depicting an example of a passive electronic component of embodiment 3 of the present disclosure.

FIG. 36 is a schematic cross-sectional view depicting an example of a cross section taken along line e1-e2 of the passive electronic component depicted in FIG. 35.

FIG. 37 is a schematic cross-sectional view depicting an example of a cross section taken along line f1-f2 of the passive electronic component depicted in FIG. 35 (excluding the first outer electrode).

FIG. 38 is a schematic plan view depicting another example of the passive electronic component of embodiment 3 of the present disclosure.

FIG. 39 is a schematic cross-sectional view depicting an example of a cross section taken along line e3-e4 of the passive electronic component depicted in FIG. 38.

FIG. 40 is a schematic cross-sectional view depicting an example of a cross section taken along line f3-f4 of the passive electronic component depicted in FIG. 38 (excluding the first outer electrode).

FIG. 41 is a schematic cross-sectional view depicting another example of the cross section taken along line f3-f4 of the passive electronic component depicted in FIG. 38 (excluding the first outer electrode).

FIG. 42 is a schematic plan view depicting still another example of the passive electronic component of embodiment 3 of the present disclosure.

FIG. 43 is a schematic cross-sectional view depicting an example of a cross section taken along line e5-e6 of the passive electronic component depicted in FIG. 42.

FIG. 44 is a schematic cross-sectional view depicting an example of a cross section taken along line f5-f6 of the passive electronic component depicted in FIG. 42 (excluding the first outer electrode).

FIG. 45 is a schematic cross-sectional view depicting another example of the cross section taken along line f5-f6 of the passive electronic component depicted in FIG. 42 (excluding the first outer electrode).

### DESCRIPTION OF THE PREFERRED EMBODIMENTS

A passive electronic component of the present disclosure is described below. The present disclosure is not limited to the following configurations, and modifications may be made as appropriate without departing from the gist of the present disclosure. Further, a combination of a plurality of individual preferable configurations described below also constitutes the present disclosure.

Each embodiment shown below is given as an example, and it is obvious that partial replacement or combination of configurations shown in different embodiments is possible. In embodiment 2 and subsequent embodiments, description of matters common to embodiment 1 is omitted, and mainly differences are described. In particular, similar operation and effects resulting from a similar configuration are not described repeatedly for each embodiment.

In the following description, when the respective embodiments are not particularly distinguished, a term “passive electronic component of the present disclosure” is simply used.

In the following, an electronic component having a capacitor is shown as an example of the passive electronic component of the present disclosure. The passive electronic component of the present disclosure may be a capacitor itself.

The drawings shown below are schematic diagrams, and dimensions, scaling of an aspect ratio, and the like thereof differ from those of an actual product in some cases.

In the present specification, unless otherwise specified, terms indicating relationships between elements (for example, “parallel,” “perpendicular,” and the like) and terms indicating shapes of elements do not mean only literal and strict aspects but also mean substantially equivalent ranges, for example, ranges including differences on the order of several percent.

### Embodiment 1

As a first aspect, a passive electronic component of the present disclosure includes a substrate having a first main surface and a second main surface opposed to each other in a first direction and a capacitor disposed on the first main surface side of the substrate. The capacitor has a capacitance forming portion in which inner electrode layers and dielectric layers are alternately laminated in the first direction. The capacitance forming portion has three or more of the inner electrode layers. In a case where, when all the inner electrode layers are counted in order from the substrate side in the first direction, a first group to which the inner electrode layers located at odd-numbered positions belong and a second group to which the inner electrode layers located at even-numbered positions belong are defined, and, when all the inner electrode layers are counted in order from the substrate side in the first direction, with N being an odd number of three or more, an Nth inner electrode layer that is located at an Nth position and belongs to the first group and an (N-1)th inner electrode layer that is located at an (N-1)th position and belongs to the second group are defined, and, in plan view from the first direction, a second direction perpendicular to an average direction of a current flowing through the capacitance forming portion when a voltage is applied to the capacitance forming portion is defined, in a cross section taken along the first direction and the second direction, both end portions of the Nth inner electrode layer of the first group in the second direction are located on an outer side in the second direction relative to both end portions of the (N-1)th inner electrode layer of the second group in the second direction.

An example of the first aspect of the passive electronic component of the present disclosure is described below as a passive electronic component of embodiment 1 of the present disclosure.

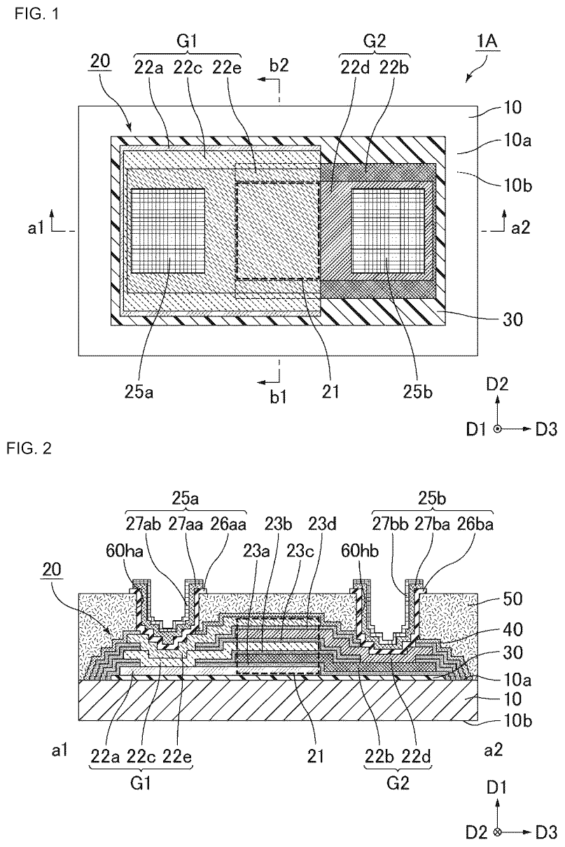

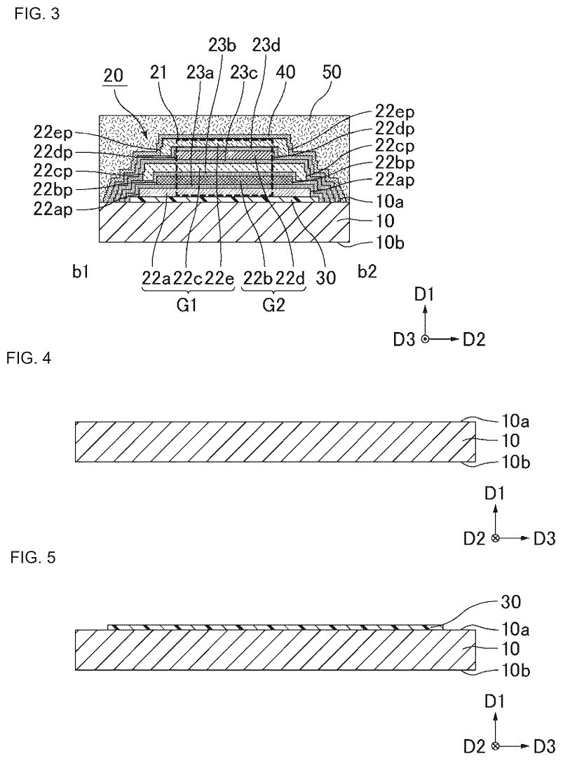

FIG. 1 is a schematic plan view depicting an example of the passive electronic component of embodiment 1 of the present disclosure. FIG. 2 is a schematic cross-sectional view depicting an example of a cross section taken along line a1-a2 of the passive electronic component depicted in FIG. 1. FIG. 3 is a schematic cross-sectional view depicting an example of a cross section taken along line b1-b2 of the passive electronic component depicted in FIG. 1 (excluding a first outer electrode).

A passive electronic component 1A depicted in FIGS. 1, 2, and 3 has a substrate 10 and a capacitor 20.

The substrate 10 has a first main surface 10a and a second main surface 10b opposed to each other in a first direction D1.

It is preferable that the substrate 10 be a semiconductor substrate. In this case, examples of a material of the substrate 10 include semiconductor materials such as silicon and gallium arsenide.

The substrate 10 may be an insulating substrate. In this case, examples of a material of the substrate 10 include insulating materials such as glass and alumina.

The capacitor 20 is disposed on the first main surface 10a side of the substrate 10.

The capacitor 20 has a capacitance forming portion 21.

In the capacitance forming portion 21, inner electrode layers and dielectric layers are alternately laminated in the first direction D1.

The capacitance forming portion 21 has three or more inner electrode layers.

In the examples depicted in FIGS. 2 and 3, the capacitance forming portion 21 is formed by laminating, in order from the substrate 10 side in the first direction D1, a first inner electrode layer 22a, a first dielectric layer 23a, a second inner electrode layer 22b, a second dielectric layer 23b, a third inner electrode layer 22c, a third dielectric layer 23c, a fourth inner electrode layer 22d, a fourth dielectric layer 23d, and a fifth inner electrode layer 22e. That is, in the examples depicted in FIGS. 2 and 3, the capacitance forming portion 21 has five inner electrode layers.

In the capacitance forming portion 21, one capacitor element having an MIM structure is composed of two inner electrode layers adjacent to each other in the first direction D1 and one dielectric layer interposed between the two inner electrode layers.

In the examples depicted in FIGS. 2 and 3, the following capacitor elements are connected in the capacitance forming portion 21: a capacitor element composed of the first inner electrode layer 22a, the first dielectric layer 23a, and the second inner electrode layer 22b; a capacitor element composed of the second inner electrode layer 22b, the second dielectric layer 23b, and the third inner electrode layer 22c; a capacitor element composed of the third inner electrode layer 22c, the third dielectric layer 23c, and the fourth inner electrode layer 22d; and a capacitor element composed of the fourth inner electrode layer 22d, the fourth dielectric layer 23d, and the fifth inner electrode layer 22e.

Examples of a material of each inner electrode layer include conductive materials such as metals typified by copper, silver, gold, aluminum, platinum, and the like and alloys containing at least one of these metals.

The materials of the respective inner electrode layers may be the same as each other, or may be different from each other, or may be partially different from each other.

Examples of a material of each dielectric layer include dielectric materials such as oxides typified by silicon dioxide, aluminum oxide, hafnium oxide, tantalum oxide, and the like and nitrides typified by silicon nitride and the like.

The materials of the respective dielectric layers may be the same as each other, or may be different from each other, or may be partially different from each other.

In FIG. 1, the respective dielectric layers described above are not depicted.

For the passive electronic component 1A, when all the inner electrode layers are counted in order from the substrate 10 side in the first direction D1, a first group G1 to which the inner electrode layers located at odd-numbered positions belong and a second group G2 to which the inner electrode layers located at even-numbered positions belong are defined.

In the examples depicted in FIGS. 1, 2, and 3, the first inner electrode layer 22a, the third inner electrode layer 22c, and the fifth inner electrode layer 22e belong to the first group G1. Further, in the examples depicted in FIGS. 1, 2, and 3, the second inner electrode layer 22b and the fourth inner electrode layer 22d belong to the second group G2.

For the passive electronic component 1A, when all the inner electrode layers are counted in order from the substrate 10 side in the first direction D1, with N being an odd number of three or more, an Nth inner electrode layer that is located at an Nth position and belongs to the first group G1 and an (N-1)th inner electrode layer that is located at an (N-1)th position and belongs to the second group G2 are defined.

In the examples depicted in FIGS. 1, 2, and 3, combinations of the Nth inner electrode layer and the (N-1)th inner electrode layer when N is an odd number of three or more correspond to a combination of the third inner electrode layer 22c and the second inner electrode layer 22b (when N=3) and a combination of the fifth inner electrode layer 22e and the fourth inner electrode layer 22d (when N=5).

For the passive electronic component 1A, in plan view from the first direction D1, a second direction D2 perpendicular to an average direction of a current flowing through the capacitance forming portion 21 when a voltage is applied to the capacitance forming portion 21 is defined. In the example depicted in FIG. 1, the second direction D2 is, among directions perpendicular to the first direction D1, a direction perpendicular to a direction passing through a first outer electrode 25a and a second outer electrode 25b described later.

The expression “when a voltage is applied to the capacitance forming portion 21” refers not to a state after the voltage has been applied to the capacitance forming portion 21 (state after charging is completed) but to a transient state during application of the voltage to the capacitance forming portion 21 (state during charging).

The expression “an average direction of a current flowing through the capacitance forming portion 21 when a voltage is applied to the capacitance forming portion 21” refers to a substantial direction of the current obtained by averaging directions of the current flowing through the capacitance forming portion 21 when the voltage is applied to the capacitance forming portion 21 as described above. In the example depicted in FIG. 1, when a voltage is applied to the capacitance forming portion 21, that is, when a voltage is applied between the first outer electrode 25a and the second outer electrode 25b described later, even in a case where a current flowing through the capacitance forming portion 21 from the second outer electrode 25b side toward the first outer electrode 25a side includes a current component flowing in a curved manner (for example, in an arcuate (bow-shaped) manner) in addition to a current component flowing linearly (for example, in a third direction D3), a substantial direction of the current obtained by averaging directions in which these current components flow is defined as the average direction of the current flowing through the capacitance forming portion 21. In the example depicted in FIG. 1, the average direction of the current flowing through the capacitance forming portion 21 when a voltage is applied to the capacitance forming portion 21 corresponds to the third direction D3 passing through the first outer electrode 25a and the second outer electrode 25b described later.

From the above, in the example depicted in FIG. 1, the first direction D1, the second direction D2, and the third direction D3 are in a relationship of being perpendicular to each other.

In the example depicted in FIG. 1, the second direction D2 corresponds to a short-side direction of the passive electronic component 1A, and the third direction D3 corresponds to a longitudinal direction of the passive electronic component 1A. The second direction D2 may correspond to the longitudinal direction of the passive electronic component 1A, and the third direction D3 may correspond to the short-side direction of the passive electronic component 1A.

For the passive electronic component 1A, in a cross section taken along the first direction D1 and the second direction D2, both end portions of the Nth inner electrode layer of the first group G1 in the second direction D2 are located on the outer side in the second direction D2 relative to both end portions of the (N-1)th inner electrode layer of the second group G2 in the second direction D2. Hereinafter, such a feature is referred to as a first feature.

For the first feature, the following configurations are depicted in FIG. 3, which depicts the example of the cross section of the passive electronic component 1A taken along the first direction D1 and the second direction D2.

### (When N=3)

In the example depicted in FIG. 3, both end portions 22cp of the third inner electrode layer 22c of the first group G1 in the second direction D2 are located on the outer side in the second direction D2 relative to both end portions 22bp of the second inner electrode layer 22b of the second group G2 in the second direction D2.

### (When N=5)

In the example depicted in FIG. 3, both end portions 22ep of the fifth inner electrode layer 22e of the first group G1 in the second direction D2 are located on the outer side in the second direction D2 relative to both end portions 22dp of the fourth inner electrode layer 22d of the second group G2 in the second direction D2.

For the passive electronic component 1A, it is preferable that, in the cross section taken along the first direction D1 and the second direction D2, the Nth inner electrode layer of the first group G1 cover, in the second direction D2, on both end portion sides in the second direction D2, at least part of the respective side surfaces (surfaces facing in the second direction D2) of the (N-1)th inner electrode layer of the second group G2 on both end portion sides in the second direction D2. In other words, it is preferable that, in the cross section taken along the first direction D1 and the second direction D2, the Nth inner electrode layer of the first group G1 cover, in the second direction D2, on both end portion sides in the second direction D2, part or the entirety of the respective side surfaces of the (N-1)th inner electrode layer of the second group G2 on both end portion sides in the second direction D2. That is, for the passive electronic component 1A, it is preferable that, in the cross section taken along the first direction D1 and the second direction D2, the Nth inner electrode layer be disposed so as to provide a lid for the (N-1)th inner electrode layer over the entire region in the second direction D2. It is preferable that the following configurations be made in FIG. 3, which depicts the example of the cross section of the passive electronic component 1A taken along the first direction D1 and the second direction D2.

### (When N=3)

In the example depicted in FIG. 3, it is preferable that the third inner electrode layer 22c of the first group G1 cover, in the second direction D2, on both end portion 22cp sides in the second direction D2, at least part of the respective side surfaces of the second inner electrode layer 22b of the second group G2 on both end portion 22bp sides in the second direction D2. That is, in the example depicted in FIG. 3, it is preferable that the third inner electrode layer 22c be disposed so as to provide a lid for the second inner electrode layer 22b over the entire region in the second direction D2.

### (When N=5)

In the example depicted in FIG. 3, it is preferable that the fifth inner electrode layer 22e of the first group G1 cover, in the second direction D2, on both end portion 22ep sides in the second direction D2, at least part of the respective side surfaces of the fourth inner electrode layer 22d of the second group G2 on both end portion 22dp sides in the second direction D2. That is, in the example depicted in FIG. 3, it is preferable that the fifth inner electrode layer 22e be disposed so as to provide a lid for the fourth inner electrode layer 22d over the entire region in the second direction D2.

In the passive electronic component 1A, due to establishment of the first feature, an electric field generated between the inner electrode layer of the first group G1 and the inner electrode layer of the second group G2 is less likely to penetrate into the substrate 10 when a voltage is applied to the capacitance forming portion 21. For example, in the passive electronic component 1A, the end portion 22cp of the third inner electrode layer 22c of the first group G1 in the second direction D2 is located on the outer side in the second direction D2 relative to the end portion 22bp of the second inner electrode layer 22b of the second group G2 in the second direction D2. Due to this, in the passive electronic component 1A, when a voltage is applied to the capacitance forming portion 21, particularly an electric field generated between a portion on the end portion 22ap side in the second direction D2 in the first inner electrode layer 22a located closest to the substrate 10 in the first group G1 and a portion on the end portion 22bp side in the second direction D2 in the second inner electrode layer 22b located closest to the substrate 10 in the second group G2 is more likely to be shielded by a portion of the third inner electrode layer 22c on the end portion 22cp side in the second direction D2. Thus, in the passive electronic component 1A, the electric field generated between the first inner electrode layer 22a and the second inner electrode layer 22b is less likely to extend around into the substrate 10 when a voltage is applied to the capacitance forming portion 21.

As described above, in the passive electronic component 1A, the electric field generated between the inner electrode layer of the first group G1 and the inner electrode layer of the second group G2 is less likely to penetrate into the substrate 10 when a voltage is applied to the capacitance forming portion 21. Thus, in the passive electronic component 1A, when a voltage is applied to the capacitance forming portion 21, power loss in the substrate 10 is less likely to occur, and as a result, the Q factor of the passive electronic component 1A is less likely to decrease.

In the passive electronic component 1A, it is sufficient that the first feature be established for a case where N is at least one of odd numbers greater than or equal to three, here, for at least one of a case where N=3 or a case where N=5. In the passive electronic component 1A, it is particularly preferable that the first feature be established for cases in which N takes all of the odd numbers greater than or equal to three, here, for both the case where N=3 and the case where N=5.

It is preferable that the capacitor 20 further have the first outer electrode 25a electrically connected to all the inner electrode layers of the first group G1.

In the example depicted in FIG. 2, the first outer electrode 25a is electrically connected to all of the first inner electrode layer 22a, the third inner electrode layer 22c, and the fifth inner electrode layer 22e belonging to the first group G1.

Examples of a material of the first outer electrode 25a include conductive materials such as metals typified by copper, nickel, silver, gold, aluminum, palladium, titanium, tin, and the like and alloys containing at least one of these metals.

The first outer electrode 25a may have a single-layer structure, or may have a multilayer structure.

When the first outer electrode 25a has a multilayer structure, as depicted in FIG. 2, the first outer electrode 25a may have, in order from the substrate 10 side, a seed layer 26aa, a first plated layer 27aa, and a second plated layer 27ab.

Examples of the seed layer 26aa include a multilayer body obtained by laminating a conductor layer made of titanium and a conductor layer made of copper in that order from the substrate 10 side.

Examples of the first plated layer 27aa include a nickel plated layer.

Examples of the second plated layer 27ab include a gold plated layer and a tin plated layer.

It is preferable that the capacitor 20 further have the second outer electrode 25b electrically connected to all the inner electrode layers of the second group G2.

In the example depicted in FIG. 2, the second outer electrode 25b is electrically connected to all of the second inner electrode layer 22b and the fourth inner electrode layer 22d belonging to the second group G2.

In the examples depicted in FIGS. 1 and 2, the second outer electrode 25b is separate from the first outer electrode 25a in a direction perpendicular to the first direction D1, here, in the third direction D3.

Examples of a material of the second outer electrode 25b include conductive materials such as metals typified by copper, nickel, silver, gold, aluminum, palladium, titanium, tin, and the like and alloys containing at least one of these metals.

The second outer electrode 25b may have a single-layer structure, or may have a multilayer structure.

When the second outer electrode 25b has a multilayer structure, as depicted in FIG. 2, the second outer electrode 25b may have, in order from the substrate 10 side, a seed layer 26ba, a first plated layer 27ba, and a second plated layer 27bb.

Examples of the seed layer 26ba include a multilayer body obtained by laminating a conductor layer made of titanium and a conductor layer made of copper in that order from the substrate 10 side.

Examples of the first plated layer 27ba include a nickel plated layer.

Examples of the second plated layer 27bb include a gold plated layer and a tin plated layer.

When the capacitor 20 has the first outer electrode 25a and the second outer electrode 25b, the capacitor 20 forms a two-terminal capacitor. When the capacitor 20 has the first outer electrode 25a and the second outer electrode 25b, the passive electronic component 1A can function as a single unit.

The materials of the first outer electrode 25a and the second outer electrode 25b may be the same as each other, or may be different from each other.

The layer structures of the first outer electrode 25a and the second outer electrode 25b may be the same as each other, or may be different from each other.

It is preferable that the passive electronic component 1A further have an insulating layer 30 disposed between the substrate 10 and the capacitor 20 in the first direction D1.

It is preferable that the insulating layer 30 be in contact with the substrate 10 in the first direction D1.

It is preferable that the insulating layer 30 be in contact with the capacitor 20 in the first direction D1.

The insulating layer 30 may be disposed so as to cover the entirety of the first main surface 10a of the substrate 10, or may be disposed so as to cover part of the first main surface 10a of the substrate 10.

When the substrate 10 is a semiconductor substrate, the presence of the insulating layer 30 reduces parasitic capacitance between the substrate 10 and the capacitor 20, and thus the Q factor of the passive electronic component 1A is more likely to be increased.

When the substrate 10 is an insulating substrate, the insulating layer 30 is not required to be disposed. When the insulating layer 30 is not disposed, it is preferable that the substrate 10 and the capacitor 20 be in contact with each other in the first direction D1.

In plan view from the first direction D1, it is preferable that a peripheral edge of the insulating layer 30 be located on the outer side relative to peripheral edges of all the inner electrode layers included in the capacitor 20.

Examples of a material of the insulating layer 30 include insulating materials such as oxides typified by silicon dioxide, aluminum oxide, and the like and nitrides typified by silicon nitride and the like.

It is preferable that the passive electronic component 1A further have a moisture-resistant protective layer 40 that covers the capacitance forming portion 21. In this case, moisture resistance of the capacitance forming portion 21 is increased. Specifically, intrusion of moisture into the inner electrode layers of the capacitance forming portion 21 is suppressed by the presence of the moisture-resistant protective layer 40. Thus, corrosion of the inner electrode layers is suppressed.

It is preferable that the moisture-resistant protective layer 40 cover, of the entirety of the inner electrode layers and the dielectric layers of the capacitor 20, regions other than regions in which the first outer electrode 25a and the second outer electrode 25b are disposed.

Examples of a material of the moisture-resistant protective layer 40 include moisture-resistant materials such as oxides typified by silicon dioxide and the like and nitrides typified by silicon nitride and the like.

In FIG. 1, the moisture-resistant protective layer 40 is not depicted.

It is preferable that the passive electronic component 1A further have a resin protective layer 50 that covers the substrate 10 and the capacitance forming portion 21. In this case, the substrate 10 and the capacitance forming portion 21 are protected from moisture.

It is preferable that the resin protective layer 50 cover, of the entirety of the inner electrode layers and the dielectric layers of the capacitor 20, regions other than regions in which the first outer electrode 25a and the second outer electrode 25b are disposed.

Examples of a material of the resin protective layer 50 include resin materials such as polyimide resin and resin in solder resist.

In FIG. 1, the resin protective layer 50 is not depicted.

When the passive electronic component 1A has the moisture-resistant protective layer 40 and the resin protective layer 50, it is preferable that the resin protective layer 50 cover the entirety of the moisture-resistant protective layer 40.

When the passive electronic component 1A has the moisture-resistant protective layer 40 and the resin protective layer 50, it is preferable that the first outer electrode 25a be disposed inside a through-hole 60ha penetrating at least the moisture-resistant protective layer 40 and the resin protective layer 50 in the first direction D1. That is, it is preferable that the first outer electrode 25a be connected to the fifth inner electrode layer 22e via the through-hole 60ha.

When the passive electronic component 1A has the moisture-resistant protective layer 40 and the resin protective layer 50, it is preferable that the second outer electrode 25b be disposed inside a through-hole 60hb penetrating at least the moisture-resistant protective layer 40 and the resin protective layer 50 in the first direction D1. That is, it is preferable that the second outer electrode 25b be connected to the fourth inner electrode layer 22d via the through-hole 60hb.

When the passive electronic component 1A has the moisture-resistant protective layer 40 and the resin protective layer 50, in the passive electronic component 1A, due to establishment of the first feature, when a voltage is applied to the capacitance forming portion 21, the electric field generated between the inner electrode layer of the first group G1 and the inner electrode layer of the second group G2 is less likely to penetrate into the substrate 10, and is also less likely to penetrate into the moisture-resistant protective layer 40 and the resin protective layer 50. For example, in the passive electronic component 1A, when a voltage is applied to the capacitance forming portion 21, the electric field generated between the portion of the first inner electrode layer 22a of the first group G1 on the end portion 22ap side in the second direction D2 and the portion of the second inner electrode layer 22b of the second group G2 on the end portion 22bp side in the second direction D2 is more likely to be shielded by the portion of the third inner electrode layer 22c on the end portion 22cp side in the second direction D2. Thus, in the passive electronic component 1A, the electric field generated between the first inner electrode layer 22a and the second inner electrode layer 22b is less likely to extend around into the moisture-resistant protective layer 40 and the resin protective layer 50 when a voltage is applied to the capacitance forming portion 21.

As described above, in the passive electronic component 1A, the electric field generated between the inner electrode layer of the first group G1 and the inner electrode layer of the second group G2 is less likely to penetrate into the moisture-resistant protective layer 40 and the resin protective layer 50 when a voltage is applied to the capacitance forming portion 21. Thus, in the passive electronic component 1A, when a voltage is applied to the capacitance forming portion 21, a deviation in the electrostatic capacity of the capacitance forming portion 21 caused by extension of the electric field along a path sequentially passing through the inner electrode layer of the first group G1, the moisture-resistant protective layer 40, the resin protective layer 50, the moisture-resistant protective layer 40, and the inner electrode layer of the second group G2 is less likely to occur. Further, in the passive electronic component 1A, when a voltage is applied to the capacitance forming portion 21, power loss according to a dielectric loss tangent (tanδ) in the resin protective layer 50 is less likely to occur, and as a result, the Q factor of the passive electronic component 1A is less likely to decrease.

The passive electronic component 1A is manufactured, for example, by the following method.

### <Step of Preparing Substrate>

FIG. 4 is a schematic cross-sectional view depicting a step of preparing a substrate in an example of a manufacturing method for the passive electronic component of embodiment 1 of the present disclosure.

As depicted in FIG. 4, the substrate 10 is prepared.

### <Step of Forming Insulating Layer>

FIG. 5 is a schematic cross-sectional view depicting a step of forming an insulating layer in the example of the manufacturing method for the passive electronic component of embodiment 1 of the present disclosure.

An insulating layer composed of an insulating material is formed on the first main surface 10a of the substrate 10 by chemical vapor deposition (CVD), physical vapor deposition (PVD), or the like. Thereafter, by patterning this insulating layer using a combination of photolithography and etching, the insulating layer 30 as depicted in FIG. 5 is formed.

### <Step of Forming First Inner Electrode Layer>

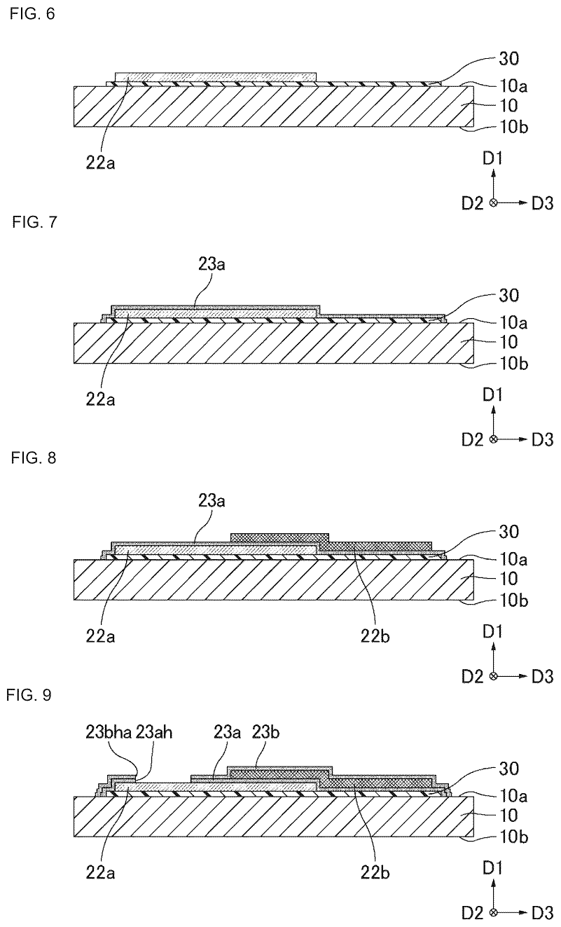

FIG. 6 is a schematic cross-sectional view depicting a step of forming a first inner electrode layer in the example of the manufacturing method for the passive electronic component of embodiment 1 of the present disclosure.

An electrode layer composed of a conductive material is formed by CVD, PVD, or the like so as to cover the structure depicted in FIG. 5 from the first main surface 10a side of the substrate 10. Thereafter, by patterning this electrode layer using a combination of photolithography and etching, the first inner electrode layer 22a as depicted in FIG. 6 is formed.

### <Step of Forming First Dielectric Layer>

FIG. 7 is a schematic cross-sectional view depicting a step of forming a first dielectric layer in the example of the manufacturing method for the passive electronic component of embodiment 1 of the present disclosure.

A dielectric layer composed of a dielectric material is formed by CVD, PVD, or the like so as to cover the structure depicted in FIG. 6 from the first main surface 10a side of the substrate 10. Thereafter, by patterning this dielectric layer using a combination of photolithography and etching, the first dielectric layer 23a as depicted in FIG. 7 is formed. Specifically, the first dielectric layer 23a is formed so as to cover the first inner electrode layer 22a and the insulating layer 30 from the first main surface 10a side of the substrate 10.

### <Step of Forming Second Inner Electrode Layer>

FIG. 8 is a schematic cross-sectional view depicting a step of forming a second inner electrode layer in the example of the manufacturing method for the passive electronic component of embodiment 1 of the present disclosure.

An electrode layer composed of a conductive material is formed by CVD, PVD, or the like so as to cover the structure depicted in FIG. 7 from the first main surface 10a side of the substrate 10. Thereafter, by patterning this electrode layer using a combination of photolithography and etching, the second inner electrode layer 22b as depicted in FIG. 8 is formed. Specifically, the second inner electrode layer 22b is formed adjacent to the first inner electrode layer 22a with the first dielectric layer 23a interposed therebetween in the first direction D1.

### <Step of Forming Second Dielectric Layer>

FIG. 9 is a schematic cross-sectional view depicting a step of forming a second dielectric layer in the example of the manufacturing method for the passive electronic component of embodiment 1 of the present disclosure.

A dielectric layer composed of a dielectric material is formed by CVD, PVD, or the like so as to cover the structure depicted in FIG. 8 from the first main surface 10a side of the substrate 10. Thereafter, by patterning this dielectric layer using a combination of photolithography and etching, the second dielectric layer 23b as depicted in FIG. 9 is formed. Specifically, the second dielectric layer 23b is formed so as to cover the second inner electrode layer 22b and the first dielectric layer 23a from the first main surface 10a side of the substrate 10. At this time, a through-hole 23ah penetrating the first dielectric layer 23a in the first direction D1 is formed such that part of the first inner electrode layer 22a is exposed. Further, a through-hole 23bha penetrating the second dielectric layer 23b in the first direction D1 is formed at a position overlapping the through-hole 23ah in the first direction D1 such that part of the first inner electrode layer 22a is exposed.

### <Step of Forming Third Inner Electrode Layer>

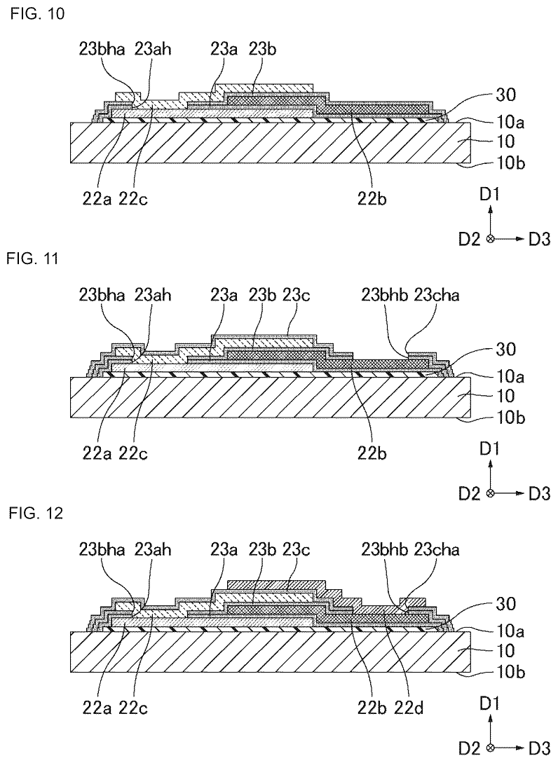

FIG. 10 is a schematic cross-sectional view depicting a step of forming a third inner electrode layer in the example of the manufacturing method for the passive electronic component of embodiment 1 of the present disclosure.

An electrode layer composed of a conductive material is formed by CVD, PVD, or the like so as to cover the structure depicted in FIG. 9 from the first main surface 10a side of the substrate 10. Thereafter, by patterning this electrode layer using a combination of photolithography and etching, the third inner electrode layer 22c as depicted in FIG. 10 is formed. Specifically, the third inner electrode layer 22c is formed adjacent to the second inner electrode layer 22b with the second dielectric layer 23b interposed therebetween in the first direction D1. Further, the third inner electrode layer 22c is formed inside the through-hole 23ah and the through-hole 23bha so as to be connected to the first inner electrode layer 22a exposed from the through-hole 23ah and the through-hole 23bha.

### <Step of Forming Third Dielectric Layer>

FIG. 11 is a schematic cross-sectional view depicting a step of forming a third dielectric layer in the example of the manufacturing method for the passive electronic component of embodiment 1 of the present disclosure.

A dielectric layer composed of a dielectric material is formed by CVD, PVD, or the like so as to cover the structure depicted in FIG. 10 from the first main surface 10a side of the substrate 10. Thereafter, by patterning this dielectric layer using a combination of photolithography and etching, the third dielectric layer 23c as depicted in FIG. 11 is formed. Specifically, the third dielectric layer 23c is formed so as to cover the third inner electrode layer 22c and the second dielectric layer 23b from the first main surface 10a side of the substrate 10. At this time, a through-hole 23bhb penetrating the second dielectric layer 23b in the first direction D1 is formed such that part of the second inner electrode layer 22b is exposed. Further, a through-hole 23cha penetrating the third dielectric layer 23c in the first direction D1 is formed at a position overlapping the through-hole 23bhb in the first direction D1 such that part of the second inner electrode layer 22b is exposed.

### <Step of Forming Fourth Inner Electrode Layer>

FIG. 12 is a schematic cross-sectional view depicting a step of forming a fourth inner electrode layer in the example of the manufacturing method for the passive electronic component of embodiment 1 of the present disclosure.

An electrode layer composed of a conductive material is formed by CVD, PVD, or the like so as to cover the structure depicted in FIG. 11 from the first main surface 10a side of the substrate 10. Thereafter, by patterning this electrode layer using a combination of photolithography and etching, the fourth inner electrode layer 22d as depicted in FIG. 12 is formed. Specifically, the fourth inner electrode layer 22d is formed adjacent to the third inner electrode layer 22c with the third dielectric layer 23c interposed therebetween in the first direction D1. Further, the fourth inner electrode layer 22d is formed inside the through-hole 23bhb and the through-hole 23cha so as to be connected to the second inner electrode layer 22b exposed from the through-hole 23bhb and the through-hole 23cha.

### <Step of Forming Fourth Dielectric Layer>

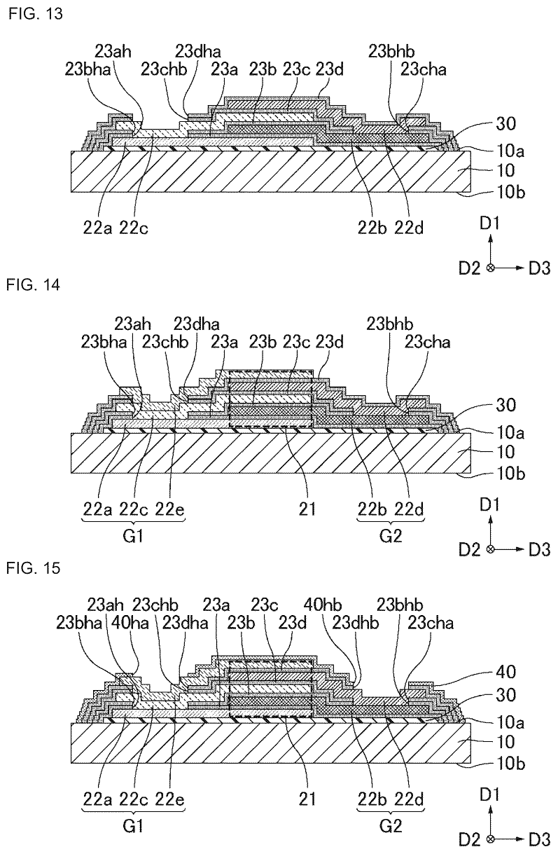

FIG. 13 is a schematic cross-sectional view depicting a step of forming a fourth dielectric layer in the example of the manufacturing method for the passive electronic component of embodiment 1 of the present disclosure.

A dielectric layer composed of a dielectric material is formed by CVD, PVD, or the like so as to cover the structure depicted in FIG. 12 from the first main surface 10a side of the substrate 10. Thereafter, by patterning this dielectric layer using a combination of photolithography and etching, the fourth dielectric layer 23d as depicted in FIG. 13 is formed. Specifically, the fourth dielectric layer 23d is formed so as to cover the fourth inner electrode layer 22d and the third dielectric layer 23c from the first main surface 10a side of the substrate 10. At this time, a through-hole 23chb penetrating the third dielectric layer 23c in the first direction D1 is formed such that part of the third inner electrode layer 22c is exposed. Further, a through-hole 23dha penetrating the fourth dielectric layer 23d in the first direction D1 is formed at a position overlapping the through-hole 23chb in the first direction D1 such that part of the third inner electrode layer 22c is exposed. It is preferable that the through-hole 23chb and the through-hole 23dha be formed at positions overlapping the through-hole 23ah and the through-hole 23bha in the first direction D1.

### <Step of Forming Fifth Inner Electrode Layer>

FIG. 14 is a schematic cross-sectional view depicting a step of forming a fifth inner electrode layer in the example of the manufacturing method for the passive electronic component of embodiment 1 of the present disclosure.

An electrode layer composed of a conductive material is formed by CVD, PVD, or the like so as to cover the structure depicted in FIG. 13 from the first main surface 10a side of the substrate 10. Thereafter, by patterning this electrode layer using a combination of photolithography and etching, the fifth inner electrode layer 22e as depicted in FIG. 14 is formed. Specifically, the fifth inner electrode layer 22e is formed adjacent to the fourth inner electrode layer 22d with the fourth dielectric layer 23d interposed therebetween in the first direction D1. Further, the fifth inner electrode layer 22e is formed inside the through-hole 23chb and the through-hole 23dha so as to be connected to the third inner electrode layer 22c exposed from the through-hole 23chb and the through-hole 23dha.

Through the above steps, the capacitance forming portion 21 is formed in which the first inner electrode layer 22a, the first dielectric layer 23a, the second inner electrode layer 22b, the second dielectric layer 23b, the third inner electrode layer 22c, the third dielectric layer 23c, the fourth inner electrode layer 22d, the fourth dielectric layer 23d, and the fifth inner electrode layer 22e are laminated in that order from the substrate 10 side in the first direction D1.

### <Step of Forming Moisture-resistant Protective Layer>

FIG. 15 is a schematic cross-sectional view depicting a step of forming a moisture-resistant protective layer in the example of the manufacturing method for the passive electronic component of embodiment 1 of the present disclosure.

A moisture-resistant layer composed of a moisture-resistant material is formed by CVD, PVD, or the like so as to cover the structure depicted in FIG. 14 from the first main surface 10a side of the substrate 10. Thereafter, by patterning this moisture-resistant layer using a combination of photolithography and etching, the moisture-resistant protective layer 40 as depicted in FIG. 15 is formed. Specifically, the moisture-resistant protective layer 40 is formed so as to cover the fifth inner electrode layer 22e and the fourth dielectric layer 23d from the first main surface 10a side of the substrate 10. At this time, a through-hole 40ha penetrating the moisture-resistant protective layer 40 in the first direction D1 is formed such that part of the fifth inner electrode layer 22e is exposed. It is preferable that the through-hole 40ha be formed at a position overlapping the through-hole 23ah, the through-hole 23bha, the through-hole 23chb, and the through-hole 23dha in the first direction D1. Further, a through-hole 23dhb penetrating the fourth dielectric layer 23d in the first direction D1 is formed such that part of the fourth inner electrode layer 22d is exposed. Moreover, a through-hole 40hb penetrating the moisture-resistant protective layer 40 in the first direction D1 is formed at a position overlapping the through-hole 23dhb in the first direction D1 such that part of the fourth inner electrode layer 22d is exposed. It is preferable that the through-hole 23dhb and the through-hole 40hb be formed at positions overlapping the through-hole 23bhb and the through-hole 23cha in the first direction D1.

### <Step of Forming Resin Protective Layer>

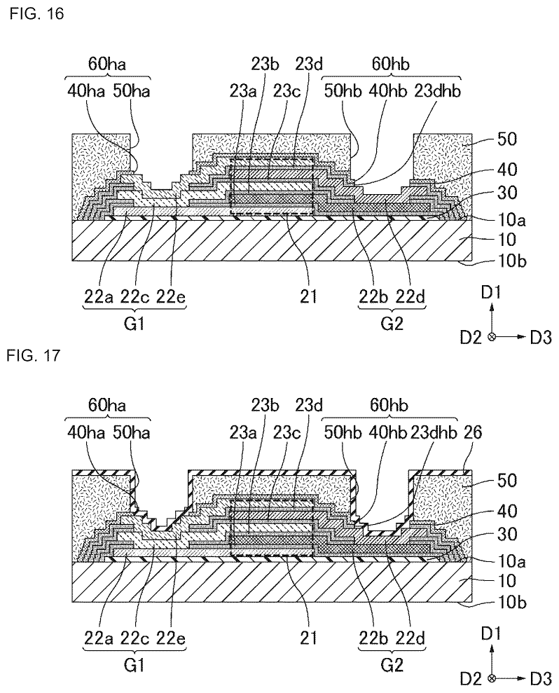

FIG. 16 is a schematic cross-sectional view depicting a step of forming a resin protective layer in the example of the manufacturing method for the passive electronic component of embodiment 1 of the present disclosure.

A resin layer composed of a resin material is formed by spin coating or the like so as to cover the structure depicted in FIG. 15 from the first main surface 10a side of the substrate 10. Thereafter, this resin layer is patterned by using only photolithography when the resin material of the resin layer is photosensitive, or by performing photolithography and etching in combination when the resin material of the resin layer is non-photosensitive, thereby forming the resin protective layer 50 as depicted in FIG. 16. Specifically, the resin protective layer 50 is formed so as to cover the substrate 10 and the moisture-resistant protective layer 40 from the first main surface 10a side of the substrate 10. At this time, a through-hole 50ha penetrating the resin protective layer 50 in the first direction D1 is formed at a position overlapping the through-hole 40ha in the first direction D1 such that part of the fifth inner electrode layer 22e is exposed. Further, a through-hole 50hb penetrating the resin protective layer 50 in the first direction D1 is formed at a position overlapping the through-hole 23dhb and the through-hole 40hb in the first direction D1 such that part of the fourth inner electrode layer 22d is exposed.

Through the above steps, the through-hole 60ha obtained by communication of the through-hole 40ha and the through-hole 50ha with each other in the first direction D1 is formed such that part of the fifth inner electrode layer 22e is exposed. Further, the through-hole 60hb obtained by communication of the through-hole 23dhb, the through-hole 40hb, and the through-hole 50hb with each other in the first direction D1 is formed such that part of the fourth inner electrode layer 22d is exposed.

### <Step of Forming First Outer Electrode and Second Outer Electrode>

FIGS. 17, 18, and 19 are schematic cross-sectional views depicting a step of forming a first outer electrode and a second outer electrode in the example of the manufacturing method for the passive electronic component of embodiment 1 of the present disclosure.

As depicted in FIG. 17, a seed layer 26 is formed so as to cover the structure depicted in FIG. 16 from the first main surface 10a side of the substrate 10.

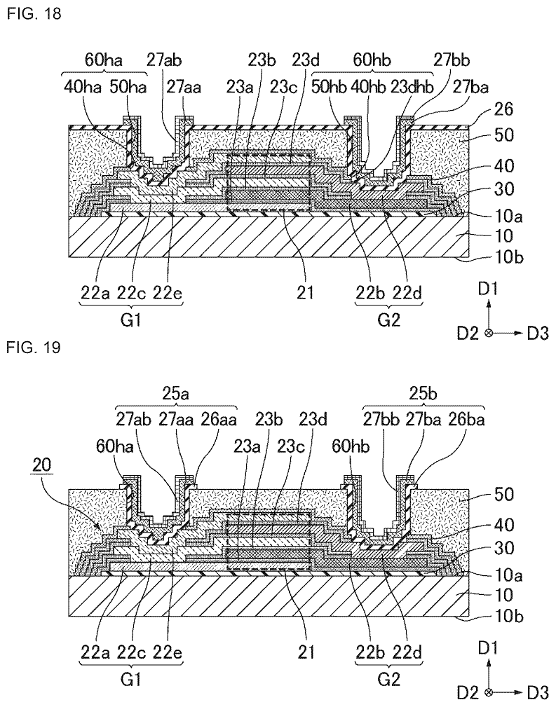

Next, by performing plating and photolithography in combination, the first plated layer 27aa and the second plated layer 27ab as depicted in FIG. 18 are sequentially formed at positions overlapping the through-hole 60ha in the first direction D1. Further, by performing plating and photolithography in combination, the first plated layer 27ba and the second plated layer 27bb as depicted in FIG. 18 are sequentially formed at positions overlapping the through-hole 60hb in the first direction D1.

Thereafter, as depicted in FIG. 19, by removing part of the seed layer 26 by etching or the like, the seed layer 26aa is formed at a position overlapping the through-hole 60ha in the first direction D1, and the seed layer 26ba is formed at a position overlapping the through-hole 60hb in the first direction D1.

In this manner, the first outer electrode 25a having, in order from the substrate 10 side, the seed layer 26aa, the first plated layer 27aa, and the second plated layer 27ab is formed. Specifically, the first outer electrode 25a is formed so as to be connected to the fifth inner electrode layer 22e via the through-hole 60ha.

Further, the second outer electrode 25b having, in order from the substrate 10 side, the seed layer 26ba, the first plated layer 27ba, and the second plated layer 27bb is formed. Specifically, the second outer electrode 25b is formed so as to be connected to the fourth inner electrode layer 22d via the through-hole 60hb.

Through the above steps, the capacitor 20 having the capacitance forming portion 21, the first outer electrode 25a, and the second outer electrode 25b is formed.

In the above-described manner, the passive electronic component 1A is manufactured.

For the first aspect of the passive electronic component of the present disclosure, FIGS. 4 to 19 depict, as an example, the case where one capacitor is formed on the substrate. However, a plurality of capacitors may be formed on the substrate. When a plurality of capacitors are formed on the substrate, the plurality of capacitors may be formed at the same timing as each other, or may be formed at different timings from each other. When a plurality of capacitors are formed on the substrate, a passive electronic component having the plurality of capacitors may be diced into passive electronic components each having one capacitor.

For the first aspect of the passive electronic component of the present disclosure, FIGS. 1, 2, and 3 depict, as an example, the case where the capacitance forming portion has five inner electrode layers. However, it is sufficient for the capacitance forming portion to have three or more inner electrode layers. That is, in the first aspect of the passive electronic component of the present disclosure, the number of inner electrode layers included in the capacitance forming portion is not limited to the above-described five layers as long as it is three or more. A case where the capacitance forming portion has four inner electrode layers is described below as an example.

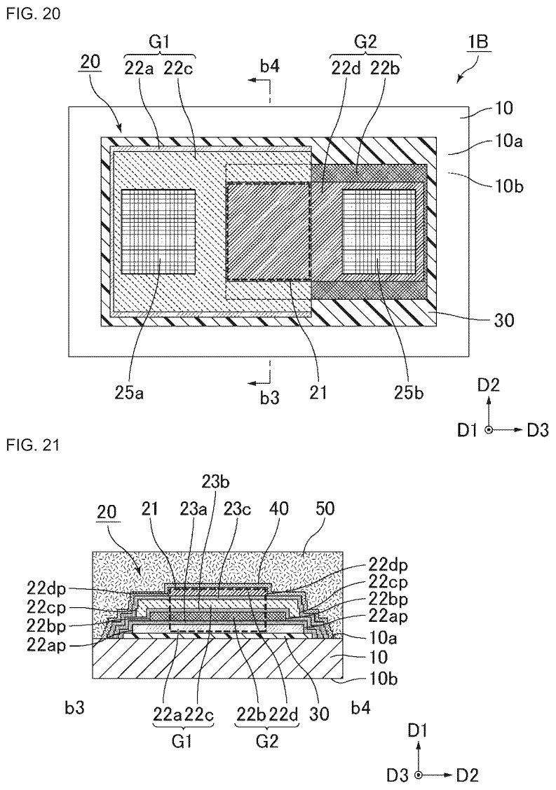

FIG. 20 is a schematic plan view depicting another example of the passive electronic component of embodiment 1 of the present disclosure. FIG. 21 is a schematic cross-sectional view depicting an example of a cross section taken along line b3-b4 of the passive electronic component depicted in FIG. 20 (excluding the first outer electrode).

In a passive electronic component 1B depicted in FIGS. 20 and 21, the capacitance forming portion 21 is formed by laminating, in order from the substrate 10 side in the first direction D1, the first inner electrode layer 22a, the first dielectric layer 23a, the second inner electrode layer 22b, the second dielectric layer 23b, the third inner electrode layer 22c, the third dielectric layer 23c, and the fourth inner electrode layer 22d. That is, in the passive electronic component 1B, the capacitance forming portion 21 has four inner electrode layers.

In the passive electronic component 1B, the capacitance forming portion 21 is disposed in a substantially central region in the third direction D3 when the capacitor 20 is viewed in plan view from the first direction D1.

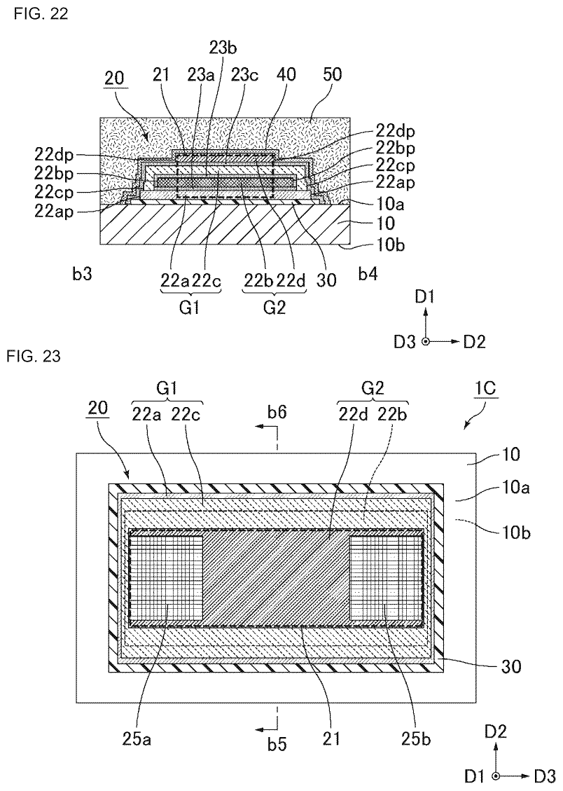

FIG. 22 is a schematic cross-sectional view depicting another example of the cross section taken along line b3-b4 of the passive electronic component depicted in FIG. 20 (excluding the first outer electrode).

For the example depicted in FIG. 22, when all the inner electrode layers are counted in order from the substrate 10 side in the first direction D1, with N being an odd number of three or more, an (N-2)th inner electrode layer that is located at an (N-2)th position and belongs to the first group G1 is defined. Specifically, in the example depicted in FIG. 22, a combination of an Nth inner electrode layer and the (N-2)th inner electrode layer when N is an odd number of three or more corresponds to a combination of the third inner electrode layer 22c and the first inner electrode layer 22a (when N=3).

For the example depicted in FIG. 22, in a cross section taken along the first direction D1 and the second direction D2, the Nth inner electrode layer and the (N-2)th inner electrode layer of the first group G1 are connected to each other on both end portion sides in the second direction D2. Specifically, in the example depicted in FIG. 22, a portion of the third inner electrode layer 22c of the first group G1 on one end portion 22cp side in the second direction D2 and a portion of the first inner electrode layer 22a of the first group G1 on one end portion 22ap side in the second direction D2 are connected to each other. Further, in the example depicted in FIG. 22, a portion of the third inner electrode layer 22c of the first group G1 on the other end portion 22cp side in the second direction D2 and a portion of the first inner electrode layer 22a of the first group G1 on the other end portion 22ap side in the second direction D2 are connected to each other.

In the example depicted in FIG. 22, unlike the example depicted in FIG. 21, the first dielectric layer 23a and the second dielectric layer 23b are not disposed between the portion of the third inner electrode layer 22c on the one end portion 22cp side in the second direction D2 and the portion of the first inner electrode layer 22a on the one end portion 22ap side in the second direction D2. Further, in the example depicted in FIG. 22, unlike the example depicted in FIG. 21, the first dielectric layer 23a and the second dielectric layer 23b are not disposed between the portion of the third inner electrode layer 22c on the other end portion 22cp side in the second direction D2 and the portion of the first inner electrode layer 22a on the other end portion 22ap side in the second direction D2.

In the example depicted in FIG. 22, in which the third inner electrode layer 22c and the first inner electrode layer 22a are connected to each other on both end portion sides in the second direction D2, for example, compared with the example depicted in FIG. 21, in which the third inner electrode layer 22c and the first inner electrode layer 22a are not connected to each other on both end portion sides in the second direction D2, when a voltage is applied to the capacitance forming portion 21, an electric field generated between the portion of the first inner electrode layer 22a on the end portion 22ap side in the second direction D2 and a portion of the second inner electrode layer 22b on the end portion 22bp side in the second direction D2 is more likely to be shielded by the portion of the third inner electrode layer 22c on the end portion 22cp side in the second direction D2. Thus, in the example depicted in FIG. 22, compared with the example depicted in FIG. 21, the electric field generated between the first inner electrode layer 22a and the second inner electrode layer 22b is less likely to penetrate into the moisture-resistant protective layer 40 and the resin protective layer 50 when a voltage is applied to the capacitance forming portion 21. Accordingly, in the example depicted in FIG. 22, compared with the example depicted in FIG. 21, when a voltage is applied to the capacitance forming portion 21, a deviation in the electrostatic capacity of the capacitance forming portion 21 is suppressed, and power loss according to a dielectric loss tangent in the resin protective layer 50 is suppressed.

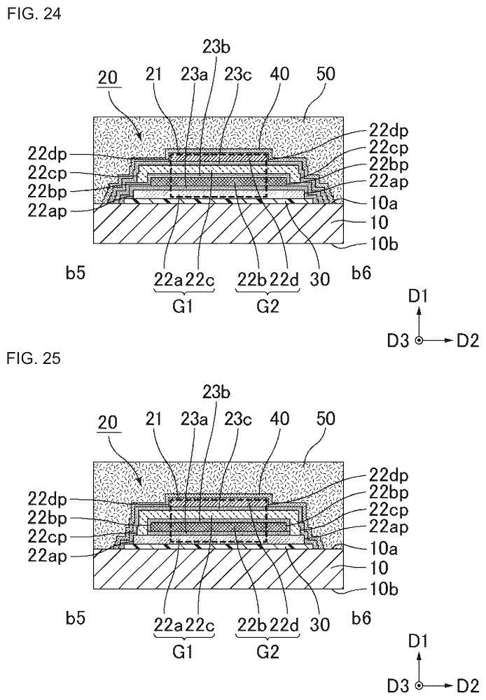

FIG. 23 is a schematic plan view depicting still another example of the passive electronic component of embodiment 1 of the present disclosure. FIG. 24 is a schematic cross-sectional view depicting an example of a cross section taken along line b5-b6 of the passive electronic component depicted in FIG. 23 (excluding the first outer electrode).

Also, in a passive electronic component 1C depicted in FIGS. 23 and 24, the capacitance forming portion 21 has four inner electrode layers, similarly to the passive electronic component 1B.

In the passive electronic component 1C, the capacitance forming portion 21 is disposed in substantially the entire region in the second direction D2 and the third direction D3 (excluding regions overlapping the first outer electrode 25a and the second outer electrode 25b) when the capacitor 20 is viewed in plan view from the first direction D1. In the passive electronic component 1C, compared with the passive electronic component 1B, the area of the inner electrode layers in the capacitance forming portion 21 when the capacitor 20 is viewed in plan view from the first direction D1 is large, and thus the electrostatic capacity of the capacitance forming portion 21 is high.

In the passive electronic component 1C, unlike the passive electronic component 1B, in plan view from the first direction D1, peripheral edges of all the inner electrode layers of the second group G2 are located on the inner side relative to a peripheral edge of the first inner electrode layer 22a located closest to the substrate 10 in the first group G1. Specifically, in the passive electronic component 1C, in plan view from the first direction D1, the peripheral edges of the second inner electrode layer 22b and the fourth inner electrode layer 22d of the second group G2 are located on the inner side relative to the peripheral edge of the first inner electrode layer 22a. Accordingly, in the passive electronic component 1C, an electric field generated between the inner electrode layer of the first group G1 and the inner electrode layer of the second group G2 is less likely to penetrate into the substrate 10 when a voltage is applied to the capacitance forming portion 21. Thus, in the passive electronic component 1C, when a voltage is applied to the capacitance forming portion 21, power loss in the substrate 10 is less likely to occur, and as a result, the Q factor of the passive electronic component 1C is less likely to decrease.

In the passive electronic component 1C, in plan view from the first direction D1, peripheral edges of the inner electrode layers of the first group G1 excluding the first inner electrode layer 22a are located on the inner side relative to the peripheral edge of the first inner electrode layer 22a. In the example depicted in FIG. 23, the peripheral edge of the third inner electrode layer 22c of the first group G1 is located on the inner side relative to the peripheral edge of the first inner electrode layer 22a.

In the passive electronic component 1C, in plan view from the first direction D1, a peripheral edge of an Nth inner electrode layer of the first group G1 when N is an odd number of three or more is located on the outer side relative to a peripheral edge of an (N-1)th inner electrode layer of the second group G2. In the example depicted in FIG. 23, the peripheral edge of the third inner electrode layer 22c of the first group G1 is located on the outer side relative to the peripheral edge of the second inner electrode layer 22b of the second group G2.

Thus, for the passive electronic component 1C, in a cross section taken along the first direction D1 and the second direction D2 (for example, FIG. 24), both end portions of the Nth inner electrode layer of the first group G1 in the second direction D2 when N is an odd number of three or more are located on the outer side in the second direction D2 relative to both end portions of the (N-1)th inner electrode layer of the second group G2 in the second direction D2. Further, for the passive electronic component 1C, in a cross section taken along the first direction D1 and the third direction D3, both end portions of the Nth inner electrode layer of the first group G1 in the third direction D3 when N is an odd number of three or more are located on the outer side in the third direction D3 relative to both end portions of the (N-1)th inner electrode layer of the second group G2 in the third direction D3.

FIG. 25 is a schematic cross-sectional view depicting another example of the cross section taken along line b5-b6 of the passive electronic component depicted in FIG. 23 (excluding the first outer electrode).

Also, for the example depicted in FIG. 25, similarly to the example depicted in FIG. 22, in the cross section taken along the first direction D1 and the second direction D2, the Nth inner electrode layer and the (N-2)th inner electrode layer of the first group G1 are connected to each other on both end portion sides in the second direction D2. Specifically, in the example depicted in FIG. 25, a portion of the third inner electrode layer 22c of the first group G1 on one end portion 22cp side in the second direction D2 and a portion of the first inner electrode layer 22a of the first group G1 on one end portion 22ap side in the second direction D2 are connected to each other. Further, in the example depicted in FIG. 25, a portion of the third inner electrode layer 22c of the first group G1 on the other end portion 22cp side in the second direction D2 and a portion of the first inner electrode layer 22a of the first group G1 on the other end portion 22ap side in the second direction D2 are connected to each other.

In the example depicted in FIG. 25, in which the third inner electrode layer 22c and the first inner electrode layer 22a are connected to each other on both end portion sides in the second direction D2, for example, compared with the example depicted in FIG. 24, in which the third inner electrode layer 22c and the first inner electrode layer 22a are not connected to each other on both end portion sides in the second direction D2, an electric field generated between the first inner electrode layer 22a and the second inner electrode layer 22b is less likely to penetrate into the moisture-resistant protective layer 40 and the resin protective layer 50 when a voltage is applied to the capacitance forming portion 21. Thus, in the example depicted in FIG. 25, compared with the example depicted in FIG. 24, when a voltage is applied to the capacitance forming portion 21, a deviation in the electrostatic capacity of the capacitance forming portion 21 is suppressed, and power loss according to a dielectric loss tangent in the resin protective layer 50 is suppressed.

### Embodiment 2

As a second aspect, a passive electronic component of the present disclosure includes a substrate having a first main surface and a second main surface opposed to each other in a first direction and a capacitor disposed on the first main surface side of the substrate. The capacitor has a capacitance forming portion in which inner electrode layers and dielectric layers are alternately laminated in the first direction. The capacitance forming portion has four or more of the inner electrode layers. In a case where, when all the inner electrode layers are counted in order from the substrate side in the first direction, a first group to which the inner electrode layers located at odd-numbered positions belong and a second group to which the inner electrode layers located at even-numbered positions belong are defined, and, when all the inner electrode layers are counted in order from the substrate side in the first direction, with N being an even number of four or more, an Nth inner electrode layer that is located at an Nth position and belongs to the second group and an (N-1)th inner electrode layer that is located at an (N-1)th position and belongs to the first group are defined, and, in plan view from the first direction, a second direction perpendicular to an average direction of a current flowing through the capacitance forming portion when a voltage is applied to the capacitance forming portion is defined, in a cross section taken along the first direction and the second direction, both end portions of the Nth inner electrode layer of the second group in the second direction are located on an outer side in the second direction relative to both end portions of the (N-1)th inner electrode layer of the first group in the second direction.

An example of the second aspect of the passive electronic component of the present disclosure is described below as a passive electronic component of embodiment 2 of the present disclosure.

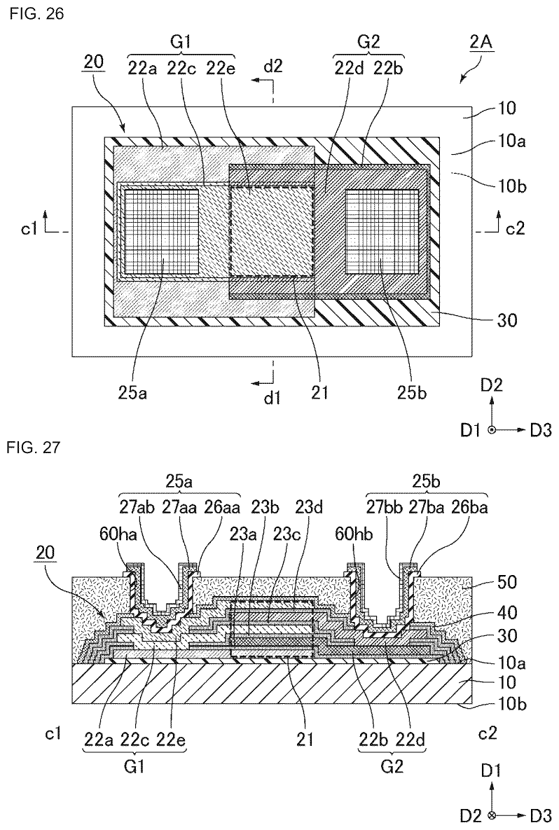

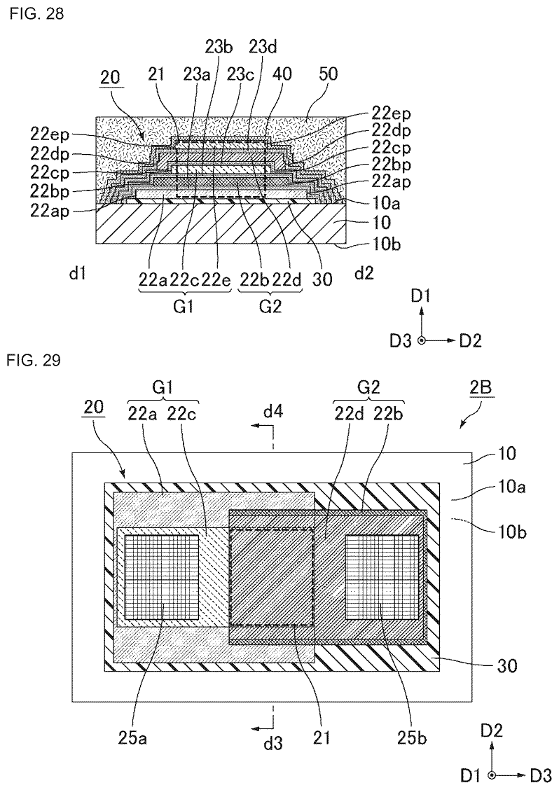

FIG. 26 is a schematic plan view depicting an example of the passive electronic component of embodiment 2 of the present disclosure. FIG. 27 is a schematic cross-sectional view depicting an example of a cross section taken along line c1-c2 of the passive electronic component depicted in FIG. 26. FIG. 28 is a schematic cross-sectional view depicting an example of a cross section taken along line d1-d2 of the passive electronic component depicted in FIG. 26 (excluding the first outer electrode).

A passive electronic component 2A depicted in FIGS. 26, 27, and 28 is similar to the passive electronic component 1A (see FIGS. 1, 2, and 3) except for the following configuration.

In the passive electronic component 2A, the capacitance forming portion 21 has four or more inner electrode layers.

In the examples depicted in FIGS. 27 and 28, the capacitance forming portion 21 is formed by laminating, in order from the substrate 10 side in the first direction D1, the first inner electrode layer 22a, the first dielectric layer 23a, the second inner electrode layer 22b, the second dielectric layer 23b, the third inner electrode layer 22c, the third dielectric layer 23c, the fourth inner electrode layer 22d, the fourth dielectric layer 23d, and the fifth inner electrode layer 22e. That is, in the examples depicted in FIGS. 27 and 28, the capacitance forming portion 21 has five inner electrode layers.

For the passive electronic component 2A, when all the inner electrode layers are counted in order from the substrate 10 side in the first direction D1, the first group G1 to which the inner electrode layers located at odd-numbered positions belong and the second group G2 to which the inner electrode layers located at even-numbered positions belong are defined.

In the examples depicted in FIGS. 26, 27, and 28, the first inner electrode layer 22a, the third inner electrode layer 22c, and the fifth inner electrode layer 22e belong to the first group G1. Further, in the examples depicted in FIGS. 26, 27, and 28, the second inner electrode layer 22b and the fourth inner electrode layer 22d belong to the second group G2.

For the passive electronic component 2A, when all the inner electrode layers are counted in order from the substrate 10 side in the first direction D1, with N being an even number of four or more, an Nth inner electrode layer that is located at an Nth position and belongs to the second group G2 and an (N-1)th inner electrode layer that is located at an (N-1)th position and belongs to the first group G1 are defined.

In the examples depicted in FIGS. 26, 27, and 28, a combination of the Nth inner electrode layer and the (N-1)th inner electrode layer when N is an even number of four or more corresponds to a combination of the fourth inner electrode layer 22d and the third inner electrode layer 22c (when N=4).

For the passive electronic component 2A, in plan view from the first direction D1, the second direction D2 perpendicular to an average direction of a current flowing through the capacitance forming portion 21 when a voltage is applied to the capacitance forming portion 21 is defined.

In the example depicted in FIG. 26, the second direction D2 is, among directions perpendicular to the first direction D1, a direction perpendicular to a direction passing through the first outer electrode 25a and the second outer electrode 25b. In the example depicted in FIG. 26, the average direction of the current flowing through the capacitance forming portion 21 when a voltage is applied to the capacitance forming portion 21 corresponds to the third direction D3 passing through the first outer electrode 25a and the second outer electrode 25b.

For the passive electronic component 2A, in a cross section taken along the first direction D1 and the second direction D2, both end portions of the Nth inner electrode layer of the second group G2 in the second direction D2 are located on the outer side in the second direction D2 relative to both end portions of the (N-1)th inner electrode layer of the first group G1 in the second direction D2. Hereinafter, such a feature is referred to as a second feature.

For the second feature, the following configurations are depicted in FIG. 28, which depicts the example of the cross section of the passive electronic component 2A taken along the first direction D1 and the second direction D2.

### (When N=4)

In the example depicted in FIG. 28, both end portions 22dp of the fourth inner electrode layer 22d of the second group G2 in the second direction D2 are located on the outer side in the second direction D2 relative to both end portions 22cp of the third inner electrode layer 22c of the first group G1 in the second direction D2.

For the passive electronic component 2A, it is preferable that, in the cross section taken along the first direction D1 and the second direction D2, the Nth inner electrode layer of the second group G2 cover, in the second direction D2, on both end portion sides in the second direction D2, at least part of the respective side surfaces (surfaces facing in the second direction D2) of the (N-1)th inner electrode layer of the first group G1 on both end portion sides in the second direction D2. In other words, it is preferable that, in the cross section taken along the first direction D1 and the second direction D2, the Nth inner electrode layer of the second group G2 cover, in the second direction D2, on both end portion sides in the second direction D2, part or the entirety of the respective side surfaces of the (N-1)th inner electrode layer of the first group G1 on both end portion sides in the second direction D2. That is, for the passive electronic component 2A, it is preferable that, in the cross section taken along the first direction D1 and the second direction D2, the Nth inner electrode layer be disposed so as to provide a lid for the (N-1)th inner electrode layer over the entire region in the second direction D2. It is preferable that the following configuration be made in FIG. 28, which depicts the example of the cross section of the passive electronic component 2A taken along the first direction D1 and the second direction D2.

### (When N=4)

In the example depicted in FIG. 28, it is preferable that the fourth inner electrode layer 22d of the second group G2 cover, in the second direction D2, on both end portion 22dp sides in the second direction D2, at least part of the respective side surfaces of the third inner electrode layer 22c of the first group G1 on both end portion 22cp sides in the second direction D2. That is, in the example depicted in FIG. 28, it is preferable that the fourth inner electrode layer 22d be disposed so as to provide a lid for the third inner electrode layer 22c over the entire region in the second direction D2.

In the passive electronic component 2A, due to establishment of the second feature, an electric field generated between the inner electrode layer of the first group G1 and the inner electrode layer of the second group G2 is less likely to penetrate into the substrate 10 when a voltage is applied to the capacitance forming portion 21. For example, in the passive electronic component 2A, the end portion 22dp of the fourth inner electrode layer 22d of the second group G2 in the second direction D2 is located on the outer side in the second direction D2 relative to the end portion 22cp of the third inner electrode layer 22c of the first group G1 in the second direction D2. Thus, in the passive electronic component 2A, when a voltage is applied to the capacitance forming portion 21, an electric field generated between a portion of the third inner electrode layer 22c of the first group G1 on the end portion 22cp side in the second direction D2 and a portion of the second inner electrode layer 22b of the second group G2 on the end portion 22bp side in the second direction D2 is more likely to be shielded by a portion of the fourth inner electrode layer 22d on the end portion 22dp side in the second direction D2. Thus, in the passive electronic component 2A, the electric field generated between the third inner electrode layer 22c and the second inner electrode layer 22b is less likely to extend around into the substrate 10 when a voltage is applied to the capacitance forming portion 21.

As described above, in the passive electronic component 2A, the electric field generated between the inner electrode layer of the first group G1 and the inner electrode layer of the second group G2 is less likely to penetrate into the substrate 10 when a voltage is applied to the capacitance forming portion 21. Thus, in the passive electronic component 2A, when a voltage is applied to the capacitance forming portion 21, power loss in the substrate 10 is less likely to occur, and as a result, the Q factor of the passive electronic component 2A is less likely to decrease.

In the passive electronic component 2A, it is sufficient that the second feature be established for a case where N is at least one of even numbers greater than or equal to four. In the passive electronic component 2A, it is particularly preferable that the second feature be established for cases in which N takes all of the even numbers greater than or equal to four.

When the passive electronic component 2A has the moisture-resistant protective layer 40 and the resin protective layer 50, in the passive electronic component 2A, due to establishment of the second feature, when a voltage is applied to the capacitance forming portion 21, the electric field generated between the inner electrode layer of the first group G1 and the inner electrode layer of the second group G2 is less likely to penetrate into the substrate 10, and is also less likely to penetrate into the moisture-resistant protective layer 40 and the resin protective layer 50. For example, in the passive electronic component 2A, when a voltage is applied to the capacitance forming portion 21, the electric field generated between the portion of the third inner electrode layer 22c of the first group G1 on the end portion 22cp side in the second direction D2 and the portion of the second inner electrode layer 22b of the second group G2 on the end portion 22bp side in the second direction D2 is more likely to be shielded by the portion of the fourth inner electrode layer 22d on the end portion 22dp side in the second direction D2. Thus, in the passive electronic component 2A, the electric field generated between the third inner electrode layer 22c and the second inner electrode layer 22b is less likely to extend around into the moisture-resistant protective layer 40 and the resin protective layer 50 when a voltage is applied to the capacitance forming portion 21.

As described above, in the passive electronic component 2A, the electric field generated between the inner electrode layer of the first group G1 and the inner electrode layer of the second group G2 is less likely to penetrate into the moisture-resistant protective layer 40 and the resin protective layer 50 when a voltage is applied to the capacitance forming portion 21. Thus, in the passive electronic component 2A, when a voltage is applied to the capacitance forming portion 21, a deviation in the electrostatic capacity of the capacitance forming portion 21 is suppressed, and power loss according to a dielectric loss tangent in the resin protective layer 50 is suppressed.

In the passive electronic component 2A, compared with the passive electronic component 1A, there is a possibility that, when a voltage is applied to the capacitance forming portion 21, an electric field generated between a portion of the first inner electrode layer 22a on the end portion 22ap side in the second direction D2 and the portion of the second inner electrode layer 22b on the end portion 22bp side in the second direction D2 penetrates into the moisture-resistant protective layer 40 and the resin protective layer 50 to some extent. Further, in the passive electronic component 2A, compared with the passive electronic component 1A, there is a possibility that, when a voltage is applied to the capacitance forming portion 21, an electric field generated between a portion of the fifth inner electrode layer 22e on the end portion 22ep side in the second direction D2 and the portion of the fourth inner electrode layer 22d on the end portion 22dp side in the second direction D2 penetrates into the moisture-resistant protective layer 40 and the resin protective layer 50 to some extent. As described above, in the passive electronic component 2A, although there is a possibility that the effect is low compared with the passive electronic component 1A, a certain degree of effect can still be obtained.

The passive electronic component 2A is manufactured, for example, similarly to the passive electronic component 1A except that an arrangement of the inner electrode layers is changed.

For the second aspect of the passive electronic component of the present disclosure, FIGS. 26, 27, and 28 depict, as an example, the case where the capacitance forming portion has five inner electrode layers. However, it is sufficient for the capacitance forming portion to have four or more inner electrode layers. That is, in the second aspect of the passive electronic component of the present disclosure, the number of inner electrode layers included in the capacitance forming portion is not limited to the above-described five layers as long as it is four or more. A case where the capacitance forming portion has four inner electrode layers is described below as an example.

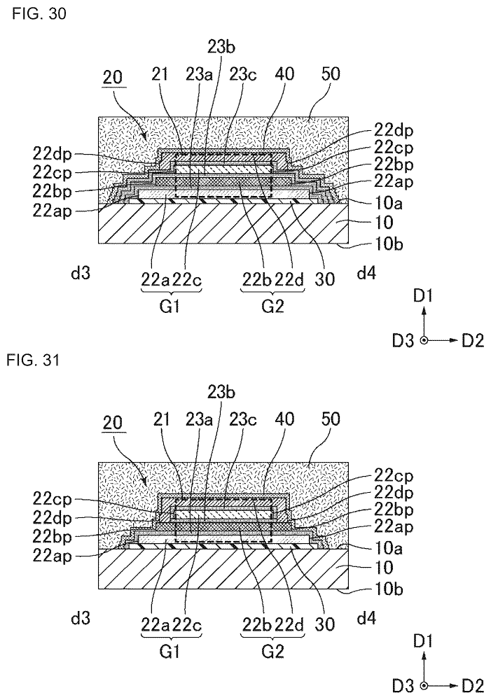

FIG. 29 is a schematic plan view depicting another example of the passive electronic component of embodiment 2 of the present disclosure. FIG. 30 is a schematic cross-sectional view depicting an example of a cross section taken along line d3-d4 of the passive electronic component depicted in FIG. 29 (excluding the first outer electrode).

In a passive electronic component 2B depicted in FIGS. 29 and 30, the capacitance forming portion 21 is formed by laminating, in order from the substrate 10 side in the first direction D1, the first inner electrode layer 22a, the first dielectric layer 23a, the second inner electrode layer 22b, the second dielectric layer 23b, the third inner electrode layer 22c, the third dielectric layer 23c, and the fourth inner electrode layer 22d. That is, in the passive electronic component 2B, the capacitance forming portion 21 has four inner electrode layers.

In the passive electronic component 2B, the capacitance forming portion 21 is disposed in a substantially central region in the third direction D3 when the capacitor 20 is viewed in plan view from the first direction D1.

FIG. 31 is a schematic cross-sectional view depicting another example of the cross section taken along line d3-d4 of the passive electronic component depicted in FIG. 29 (excluding the first outer electrode).

For the example depicted in FIG. 31, when all the inner electrode layers are counted in order from the substrate 10 side in the first direction D1, with N being an even number of four or more, an (N-2)th inner electrode layer that is located at an (N-2)th position and belongs to the second group G2 is defined. Specifically, in the example depicted in FIG. 31, a combination of an Nth inner electrode layer and the (N-2)th inner electrode layer when N is an even number of four or more corresponds to a combination of the fourth inner electrode layer 22d and the second inner electrode layer 22b (when N=4).

For the example depicted in FIG. 31, in a cross section taken along the first direction D1 and the second direction D2, the Nth inner electrode layer and the (N-2)th inner electrode layer of the second group G2 are connected to each other on both end portion sides in the second direction D2. Specifically, in the example depicted in FIG. 31, a portion of the fourth inner electrode layer 22d of the second group G2 on one end portion 22dp side in the second direction D2 and a portion of the second inner electrode layer 22b of the second group G2 on one end portion 22bp side in the second direction D2 are connected to each other. Further, in the example depicted in FIG. 31, a portion of the fourth inner electrode layer 22d of the second group G2 on the other end portion 22dp side in the second direction D2 and a portion of the second inner electrode layer 22b of the second group G2 on the other end portion 22bp side in the second direction D2 are connected to each other.

In the example depicted in FIG. 31, unlike the example depicted in FIG. 30, the second dielectric layer 23b and the third dielectric layer 23c are not disposed between the portion of the fourth inner electrode layer 22d on the one end portion 22dp side in the second direction D2 and the portion of the second inner electrode layer 22b on the one end portion 22bp side in the second direction D2. Further, in the example depicted in FIG. 31, unlike the example depicted in FIG. 30, the second dielectric layer 23b and the third dielectric layer 23c are not disposed between the portion of the fourth inner electrode layer 22d on the other end portion 22dp side in the second direction D2 and the portion of the second inner electrode layer 22b on the other end portion 22bp side in the second direction D2.

In the example depicted in FIG. 31, in which the fourth inner electrode layer 22d and the second inner electrode layer 22b are connected to each other on both end portion sides in the second direction D2, for example, compared with the example depicted in FIG. 30, in which the fourth inner electrode layer 22d and the second inner electrode layer 22b are not connected to each other on both end portion sides in the second direction D2, when a voltage is applied to the capacitance forming portion 21, an electric field generated between a portion of the third inner electrode layer 22c on the end portion 22cp side in the second direction D2 and the portion of the second inner electrode layer 22b on the end portion 22bp side in the second direction D2 is more likely to be shielded by the portion of the fourth inner electrode layer 22d on the end portion 22dp side in the second direction D2. Thus, in the example depicted in FIG. 31, compared with the example depicted in FIG. 30, the electric field generated between the third inner electrode layer 22c and the second inner electrode layer 22b is less likely to penetrate into the moisture-resistant protective layer 40 and the resin protective layer 50 when a voltage is applied to the capacitance forming portion 21. Thus, in the example depicted in FIG. 31, compared with the example depicted in FIG. 30, when a voltage is applied to the capacitance forming portion 21, a deviation in the electrostatic capacity of the capacitance forming portion 21 is suppressed, and power loss according to a dielectric loss tangent in the resin protective layer 50 is suppressed.

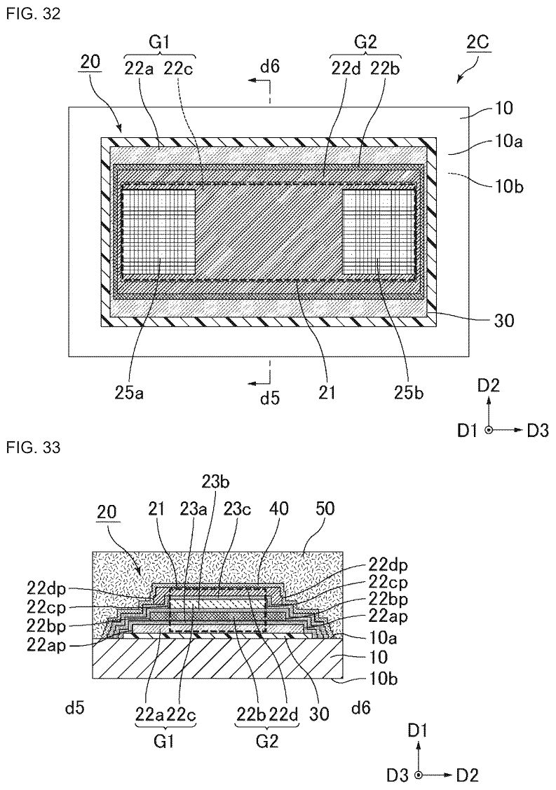

FIG. 32 is a schematic plan view depicting still another example of the passive electronic component of embodiment 2 of the present disclosure. FIG. 33 is a schematic cross-sectional view depicting an example of a cross section taken along line d5-d6 of the passive electronic component depicted in FIG. 32 (excluding the first outer electrode).

Also, in a passive electronic component 2C depicted in FIGS. 32 and 33, the capacitance forming portion 21 has four inner electrode layers, similarly to the passive electronic component 2B.

In the passive electronic component 2C, the capacitance forming portion 21 is disposed in substantially the entire region in the second direction D2 and the third direction D3 (excluding regions overlapping the first outer electrode 25a and the second outer electrode 25b) when the capacitor 20 is viewed in plan view from the first direction D1. In the passive electronic component 2C, compared with the passive electronic component 2B, the area of the inner electrode layers in the capacitance forming portion 21 when the capacitor 20 is viewed in plan view from the first direction D1 is large, and thus the electrostatic capacity of the capacitance forming portion 21 is high.

In the passive electronic component 2C, unlike the passive electronic component 2B, in plan view from the first direction D1, peripheral edges of all the inner electrode layers of the second group G2 are located on the inner side relative to a peripheral edge of the first inner electrode layer 22a located closest to the substrate 10 in the first group G1. Specifically, in the passive electronic component 2C, in plan view from the first direction D1, the peripheral edges of the second inner electrode layer 22b and the fourth inner electrode layer 22d of the second group G2 are located on the inner side relative to the peripheral edge of the first inner electrode layer 22a. Accordingly, in the passive electronic component 2C, an electric field generated between the inner electrode layer of the first group G1 and the inner electrode layer of the second group G2 is less likely to penetrate into the substrate 10 when a voltage is applied to the capacitance forming portion 21. Thus, in the passive electronic component 2C, when a voltage is applied to the capacitance forming portion 21, power loss in the substrate 10 is less likely to occur, and as a result, the Q factor of the passive electronic component 2C is less likely to decrease.

In the passive electronic component 2C, in plan view from the first direction D1, peripheral edges of the inner electrode layers of the first group G1 excluding the first inner electrode layer 22a are located on the inner side relative to the peripheral edge of the first inner electrode layer 22a. In the example depicted in FIG. 32, the peripheral edge of the third inner electrode layer 22c of the first group G1 is located on the inner side relative to the peripheral edge of the first inner electrode layer 22a.

In the passive electronic component 2C, in plan view from the first direction D1, a peripheral edge of an Nth inner electrode layer of the second group G2 when N is an even number of four or more is located on the outer side relative to a peripheral edge of an (N-1)th inner electrode layer of the first group G1. In the example depicted in FIG. 32, the peripheral edge of the fourth inner electrode layer 22d of the second group G2 is located on the outer side relative to the peripheral edge of the third inner electrode layer 22c of the first group G1.

Thus, for the passive electronic component 2C, in a cross section taken along the first direction D1 and the second direction D2 (for example, FIG. 33), both end portions of the Nth inner electrode layer of the second group G2 in the second direction D2 when N is an even number of four or more are located on the outer side in the second direction D2 relative to both end portions of the (N-1)th inner electrode layer of the first group G1 in the second direction D2. Further, for the passive electronic component 2C, in a cross section taken along the first direction D1 and the third direction D3, both end portions of the Nth inner electrode layer of the second group G2 in the third direction D3 when N is an even number of four or more are located on the outer side in the third direction D3 relative to both end portions of the (N-1)th inner electrode layer of the first group G1 in the third direction D3.

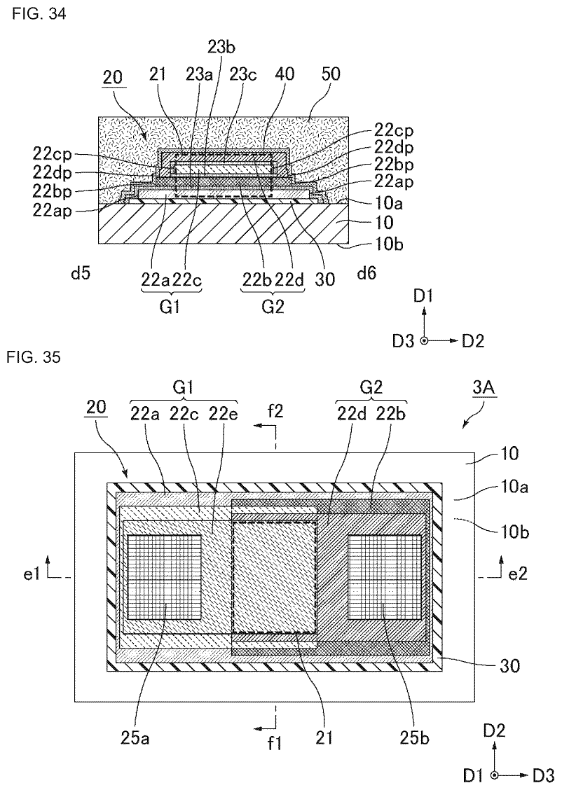

FIG. 34 is a schematic cross-sectional view depicting another example of the cross section taken along line d5-d6 of the passive electronic component depicted in FIG. 32 (excluding the first outer electrode).

Also, for the example depicted in FIG. 34, similarly to the example depicted in FIG. 31, in the cross section taken along the first direction D1 and the second direction D2, the Nth inner electrode layer and an (N-2)th inner electrode layer of the second group G2 are connected to each other on both end portion sides in the second direction D2. Specifically, in the example depicted in FIG. 34, a portion of the fourth inner electrode layer 22d of the second group G2 on one end portion 22dp side in the second direction D2 and a portion of the second inner electrode layer 22b of the second group G2 on one end portion 22bp side in the second direction D2 are connected to each other. Further, in the example depicted in FIG. 34, a portion of the fourth inner electrode layer 22d of the second group G2 on the other end portion 22dp side in the second direction D2 and a portion of the second inner electrode layer 22b of the second group G2 on the other end portion 22bp side in the second direction D2 are connected to each other.

In the example depicted in FIG. 34, in which the fourth inner electrode layer 22d and the second inner electrode layer 22b are connected to each other on both end portion sides in the second direction D2, for example, compared with the example depicted in FIG. 33, in which the fourth inner electrode layer 22d and the second inner electrode layer 22b are not connected to each other on both end portion sides in the second direction D2, an electric field generated between the third inner electrode layer 22c and the second inner electrode layer 22b is less likely to penetrate into the moisture-resistant protective layer 40 and the resin protective layer 50 when a voltage is applied to the capacitance forming portion 21. Thus, in the example depicted in FIG. 34, compared with the example depicted in FIG. 33, when a voltage is applied to the capacitance forming portion 21, a deviation in the electrostatic capacity of the capacitance forming portion 21 is suppressed, and power loss according to a dielectric loss tangent in the resin protective layer 50 is suppressed.

### Embodiment 3

As a third aspect, a passive electronic component of the present disclosure includes a substrate having a first main surface and a second main surface opposed to each other in a first direction and a capacitor disposed on the first main surface side of the substrate. The capacitor has a capacitance forming portion in which inner electrode layers and dielectric layers are alternately laminated in the first direction. The capacitance forming portion has three or more of the inner electrode layers. In a case where, when all the inner electrode layers are counted in order from the substrate side in the first direction, a first group to which the inner electrode layers located at odd-numbered positions belong and a second group to which the inner electrode layers located at even-numbered positions belong are defined, in plan view from the first direction, peripheral edges of all the inner electrode layers of the second group are located on an inner side relative to a peripheral edge of a first inner electrode layer located closest to the substrate in the first group.

An example of the third aspect of the passive electronic component of the present disclosure is described below as a passive electronic component of embodiment 3 of the present disclosure.

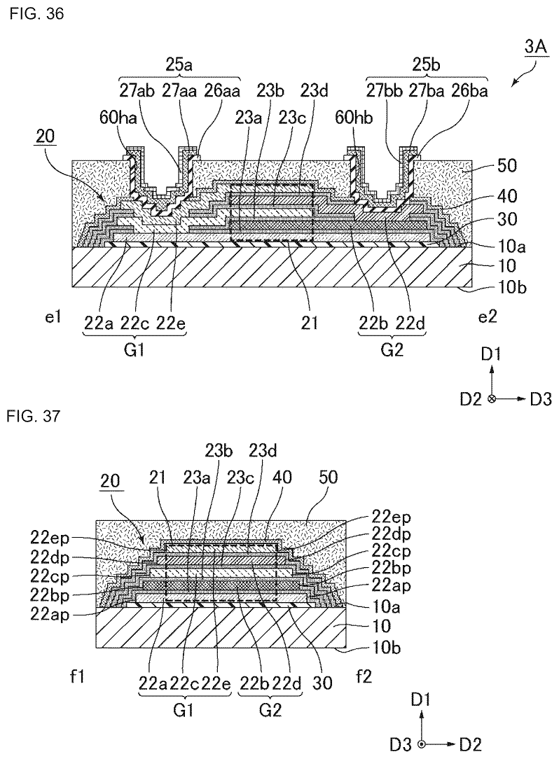

FIG. 35 is a schematic plan view depicting an example of the passive electronic component of embodiment 3 of the present disclosure. FIG. 36 is a schematic cross-sectional view depicting an example of a cross section taken along line e1-e2 of the passive electronic component depicted in FIG. 35. FIG. 37 is a schematic cross-sectional view depicting an example of a cross section taken along line f1-f2 of the passive electronic component depicted in FIG. 35 (excluding the first outer electrode).

A passive electronic component 3A depicted in FIGS. 35, 36, and 37 is similar to the passive electronic component 1A (see FIGS. 1, 2, and 3) except for the following configuration.

For the passive electronic component 3A, when all the inner electrode layers are counted in order from the substrate 10 side in the first direction D1, the first group G1 to which the inner electrode layers located at odd-numbered positions belong and the second group G2 to which the inner electrode layers located at even-numbered positions belong are defined.

In the examples depicted in FIGS. 35, 36, and 37, the first inner electrode layer 22a, the third inner electrode layer 22c, and the fifth inner electrode layer 22e belong to the first group G1. Further, in the examples depicted in FIGS. 35, 36, and 37, the second inner electrode layer 22b and the fourth inner electrode layer 22d belong to the second group G2.

For the passive electronic component 3A, in plan view from the first direction D1, peripheral edges of all the inner electrode layers of the second group G2 are located on the inner side relative to a peripheral edge of the first inner electrode layer 22a located closest to the substrate 10 in the first group G1. Hereinafter, such a feature is referred to as a third feature.

For the third feature, the following configuration is depicted in FIG. 35, which depicts a state in which the passive electronic component 3A is viewed in plan view from the first direction D1.

In the example depicted in FIG. 35, the peripheral edges of the second inner electrode layer 22b and the fourth inner electrode layer 22d of the second group G2 are both located on the inner side relative to the peripheral edge of the first inner electrode layer 22a.

In the passive electronic component 3A, due to establishment of the third feature, an electric field generated between the inner electrode layer of the first group G1 and the inner electrode layer of the second group G2 is less likely to penetrate into the substrate 10 when a voltage is applied to the capacitance forming portion 21. For example, in the passive electronic component 3A, when a voltage is applied to the capacitance forming portion 21, particularly an electric field generated between a portion on the end portion 22ap side in the second direction D2 in the first inner electrode layer 22a located closest to the substrate 10 in the first group G1 and a portion on the end portion 22bp side in the second direction D2 in the second inner electrode layer 22b located closest to the substrate 10 in the second group G2 is less likely to extend around into the substrate 10.

As described above, in the passive electronic component 3A, the electric field generated between the inner electrode layer of the first group G1 and the inner electrode layer of the second group G2 is less likely to penetrate into the substrate 10 when a voltage is applied to the capacitance forming portion 21. Thus, in the passive electronic component 3A, when a voltage is applied to the capacitance forming portion 21, power loss in the substrate 10 is less likely to occur, and as a result, the Q factor of the passive electronic component 3A is less likely to decrease.

In the passive electronic component 3A, in plan view from the first direction D1, peripheral edges of the inner electrode layers of the first group G1 excluding the first inner electrode layer 22a are located on the inner side relative to the peripheral edge of the first inner electrode layer 22a. In the example depicted in FIG. 35, the peripheral edge of the third inner electrode layer 22c of the first group G1 is located on the inner side relative to the peripheral edge of the first inner electrode layer 22a.

The passive electronic component 3A is manufactured, for example, similarly to the passive electronic component 1A except that an arrangement of the inner electrode layers is changed.

For the third aspect of the passive electronic component of the present disclosure, FIGS. 35, 36, and 37 depict, as an example, the case where the capacitance forming portion has five inner electrode layers. However, it is sufficient for the capacitance forming portion to have three or more inner electrode layers. That is, in the third aspect of the passive electronic component of the present disclosure, the number of inner electrode layers included in the capacitance forming portion is not limited to the above-described five layers as long as it is three or more. A case where the capacitance forming portion has four inner electrode layers is described below as an example.

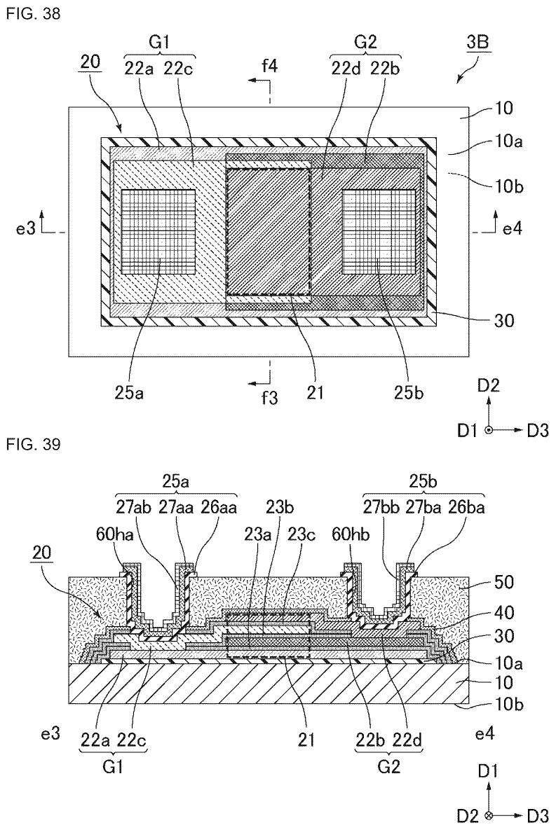

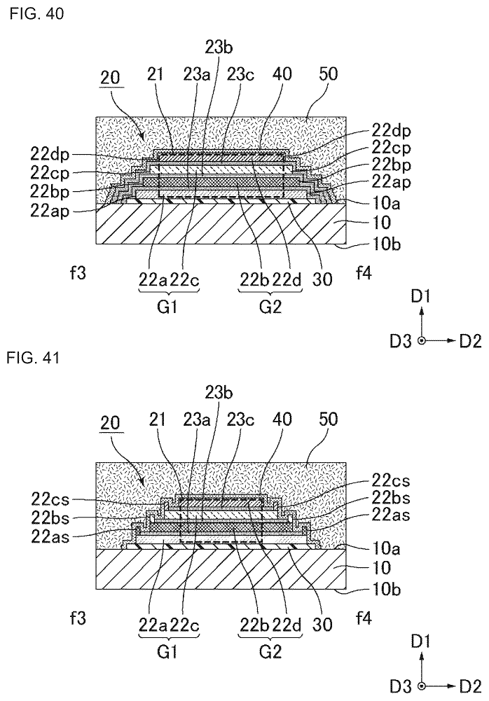

FIG. 38 is a schematic plan view depicting another example of the passive electronic component of embodiment 3 of the present disclosure. FIG. 39 is a schematic cross-sectional view depicting an example of a cross section taken along line e3-e4 of the passive electronic component depicted in FIG. 38. FIG. 40 is a schematic cross-sectional view depicting an example of a cross section taken along line f3-f4 of the passive electronic component depicted in FIG. 38 (excluding the first outer electrode).

In a passive electronic component 3B depicted in FIGS. 38, 39, and 40, the capacitance forming portion 21 is formed by laminating, in order from the substrate 10 side in the first direction D1, the first inner electrode layer 22a, the first dielectric layer 23a, the second inner electrode layer 22b, the second dielectric layer 23b, the third inner electrode layer 22c, the third dielectric layer 23c, and the fourth inner electrode layer 22d. That is, in the passive electronic component 3B, the capacitance forming portion 21 has four inner electrode layers.

In the passive electronic component 3B, the capacitance forming portion 21 is disposed in a substantially central region in the third direction D3 when the capacitor 20 is viewed in plan view from the first direction D1.

FIG. 41 is a schematic cross-sectional view depicting another example of the cross section taken along line f3-f4 of the passive electronic component depicted in FIG. 38 (excluding the first outer electrode).

In the example depicted in FIG. 41, at least one of the inner electrode layers of the first group G1 is provided with a protrusion that protrudes in the first direction D1 from portions on both end portion sides in the second direction D2. Further, in the example depicted in FIG. 41, the protrusion contains the same material as the inner electrode layer of the second group G2 adjacent, on a side opposite to the substrate 10, to the inner electrode layer of the first group G1 provided with the protrusion. Specifically, this is as follows.

In the example depicted in FIG. 41, the first inner electrode layer 22a is provided with a protrusion 22as that protrudes in the first direction D1 from portions on both end portion 22ap sides in the second direction D2. Further, in the example depicted in FIG. 41, the protrusion 22as of the first inner electrode layer 22a contains the same material as the second inner electrode layer 22b adjacent to the first inner electrode layer 22a on the side opposite to the substrate 10.

In the example depicted in FIG. 41, when a voltage is applied to the capacitance forming portion 21, the protrusion 22as of the first inner electrode layer 22a functions like an antenna with respect to an electric field generated between a portion of the first inner electrode layer 22a on the end portion 22ap side in the second direction D2 and a portion of the second inner electrode layer 22b on the end portion 22bp side in the second direction D2.

Thus, in the example depicted in FIG. 41, in which the first inner electrode layer 22a is provided with the protrusion 22as, for example, compared with the example depicted in FIG. 40, in which the first inner electrode layer 22a is not provided with the protrusion 22as, the electric field generated between the first inner electrode layer 22a and the second inner electrode layer 22b is less likely to penetrate into the substrate 10 when a voltage is applied to the capacitance forming portion 21. Accordingly, in the example depicted in FIG. 41, compared with the example depicted in FIG. 40, when a voltage is applied to the capacitance forming portion 21, power loss in the substrate 10 is less likely to occur, and as a result, the Q factor of the passive electronic component 3B is less likely to decrease.

Further, when the passive electronic component 3B has the moisture-resistant protective layer 40 and the resin protective layer 50, in the example depicted in FIG. 41, compared with the example depicted in FIG. 40, the electric field generated between the first inner electrode layer 22a and the second inner electrode layer 22b is less likely to penetrate into the moisture-resistant protective layer 40 and the resin protective layer 50 when a voltage is applied to the capacitance forming portion 21. Thus, in the example depicted in FIG. 41, compared with the example depicted in FIG. 40, when a voltage is applied to the capacitance forming portion 21, a deviation in the electrostatic capacity of the capacitance forming portion 21 is suppressed, and power loss according to a dielectric loss tangent in the resin protective layer 50 is suppressed.

The protrusion 22as of the first inner electrode layer 22a can be formed at the same timing as the second inner electrode layer 22b because the protrusion 22as contains the same material as the second inner electrode layer 22b.

In the example depicted in FIG. 41, the third inner electrode layer 22c is provided with a protrusion 22cs that protrudes in the first direction D1 from portions on both end portion 22cp sides in the second direction D2. Further, in the example depicted in FIG. 41, the protrusion 22cs of the third inner electrode layer 22c contains the same material as the fourth inner electrode layer 22d adjacent to the third inner electrode layer 22c on the side opposite to the substrate 10.

In the example depicted in FIG. 41, when a voltage is applied to the capacitance forming portion 21, the protrusion 22cs of the third inner electrode layer 22c functions like an antenna with respect to an electric field generated between a portion of the third inner electrode layer 22c on the end portion 22cp side in the second direction D2 and the portion of the second inner electrode layer 22b on the end portion 22bp side in the second direction D2. Further, in the example depicted in FIG. 41, when a voltage is applied to the capacitance forming portion 21, the protrusion 22cs of the third inner electrode layer 22c functions like an antenna with respect to an electric field generated between the portion of the third inner electrode layer 22c on the end portion 22cp side in the second direction D2 and a portion of the fourth inner electrode layer 22d on the end portion 22dp side in the second direction D2.

Thus, in the example depicted in FIG. 41, in which the third inner electrode layer 22c is provided with the protrusion 22cs, for example, compared with the example depicted in FIG. 40, in which the third inner electrode layer 22c is not provided with the protrusion 22cs, the electric field generated between the third inner electrode layer 22c and the second inner electrode layer 22b and the electric field generated between the third inner electrode layer 22c and the fourth inner electrode layer 22d are less likely to penetrate into the substrate 10 when a voltage is applied to the capacitance forming portion 21. Accordingly, in the example depicted in FIG. 41, compared with the example depicted in FIG. 40, when a voltage is applied to the capacitance forming portion 21, power loss in the substrate 10 is less likely to occur, and as a result, the Q factor of the passive electronic component 3B is less likely to decrease.

Further, when the passive electronic component 3B has the moisture-resistant protective layer 40 and the resin protective layer 50, in the example depicted in FIG. 41, compared with the example depicted in FIG. 40, the electric field generated between the third inner electrode layer 22c and the second inner electrode layer 22b and the electric field generated between the third inner electrode layer 22c and the fourth inner electrode layer 22d are less likely to penetrate into the moisture-resistant protective layer 40 and the resin protective layer 50 when a voltage is applied to the capacitance forming portion 21. Thus, in the example depicted in FIG. 41, compared with the example depicted in FIG. 40, when a voltage is applied to the capacitance forming portion 21, a deviation in the electrostatic capacity of the capacitance forming portion 21 is suppressed, and power loss according to a dielectric loss tangent in the resin protective layer 50 is suppressed.

The protrusion 22cs of the third inner electrode layer 22c can be formed at the same timing as the fourth inner electrode layer 22d because the protrusion 22cs contains the same material as the fourth inner electrode layer 22d.

As long as the inner electrode layer of the second group G2 adjacent to the inner electrode layer of the first group G1 on the side opposite to the substrate 10 is disposed, all the inner electrode layers of the first group G1 (in the example depicted in FIG. 41, the first inner electrode layer 22a and the third inner electrode layer 22c) may be provided with the protrusion, or part of the inner electrode layers of the first group G1 (in the example depicted in FIG. 41, one of the first inner electrode layer 22a or the third inner electrode layer 22c) may be provided with the protrusion. In particular, it is preferable that all the inner electrode layers of the first group G1 be provided with the protrusion.

In the example depicted in FIG. 41, at least one of the inner electrode layers of the second group G2 is provided with a protrusion that protrudes in the first direction D1 from portions on both end portion sides in the second direction D2. Further, in the example depicted in FIG. 41, the protrusion contains the same material as the inner electrode layer of the first group G1 adjacent, on the side opposite to the substrate 10, to the inner electrode layer of the second group G2 provided with the protrusion. Specifically, this is as follows.

In the example depicted in FIG. 41, the second inner electrode layer 22b is provided with a protrusion 22bs that protrudes in the first direction D1 from portions on both end portion 22bp sides in the second direction D2. Further, in the example depicted in FIG. 41, the protrusion 22bs of the second inner electrode layer 22b contains the same material as the third inner electrode layer 22c adjacent to the second inner electrode layer 22b on the side opposite to the substrate 10.

In the example depicted in FIG. 41, when a voltage is applied to the capacitance forming portion 21, the protrusion 22bs of the second inner electrode layer 22b functions like an antenna with respect to the electric field generated between the portion of the second inner electrode layer 22b on the end portion 22bp side in the second direction D2 and the portion of the first inner electrode layer 22a on the end portion 22ap side in the second direction D2. Further, in the example depicted in FIG. 41, when a voltage is applied to the capacitance forming portion 21, the protrusion 22bs of the second inner electrode layer 22b functions like an antenna with respect to the electric field generated between the portion of the second inner electrode layer 22b on the end portion 22bp side in the second direction D2 and the portion of the third inner electrode layer 22c on the end portion 22cp side in the second direction D2.

Thus, in the example depicted in FIG. 41, in which the second inner electrode layer 22b is provided with the protrusion 22bs, for example, compared with the example depicted in FIG. 40, in which the second inner electrode layer 22b is not provided with the protrusion 22bs, the electric field generated between the second inner electrode layer 22b and the first inner electrode layer 22a and the electric field generated between the second inner electrode layer 22b and the third inner electrode layer 22c are less likely to penetrate into the substrate 10 when a voltage is applied to the capacitance forming portion 21. Accordingly, in the example depicted in FIG. 41, compared with the example depicted in FIG. 40, when a voltage is applied to the capacitance forming portion 21, power loss in the substrate 10 is less likely to occur, and as a result, the Q factor of the passive electronic component 3B is less likely to decrease.

Further, when the passive electronic component 3B has the moisture-resistant protective layer 40 and the resin protective layer 50, in the example depicted in FIG. 41, compared with the example depicted in FIG. 40, the electric field generated between the second inner electrode layer 22b and the first inner electrode layer 22a and the electric field generated between the second inner electrode layer 22b and the third inner electrode layer 22c are less likely to penetrate into the moisture-resistant protective layer 40 and the resin protective layer 50 when a voltage is applied to the capacitance forming portion 21. Thus, in the example depicted in FIG. 41, compared with the example depicted in FIG. 40, when a voltage is applied to the capacitance forming portion 21, a deviation in the electrostatic capacity of the capacitance forming portion 21 is suppressed, and power loss according to a dielectric loss tangent in the resin protective layer 50 is suppressed.

The protrusion 22bs of the second inner electrode layer 22b can be formed at the same timing as the third inner electrode layer 22c because the protrusion 22bs contains the same material as the third inner electrode layer 22c.

As long as the inner electrode layer of the first group G1 adjacent to the inner electrode layer of the second group G2 on the side opposite to the substrate 10 is disposed, all the inner electrode layers of the second group G2 may be provided with the protrusion, or part of the inner electrode layers of the second group G2 may be provided with the protrusion. In particular, it is preferable that all the inner electrode layers of the second group G2 be provided with the protrusion.

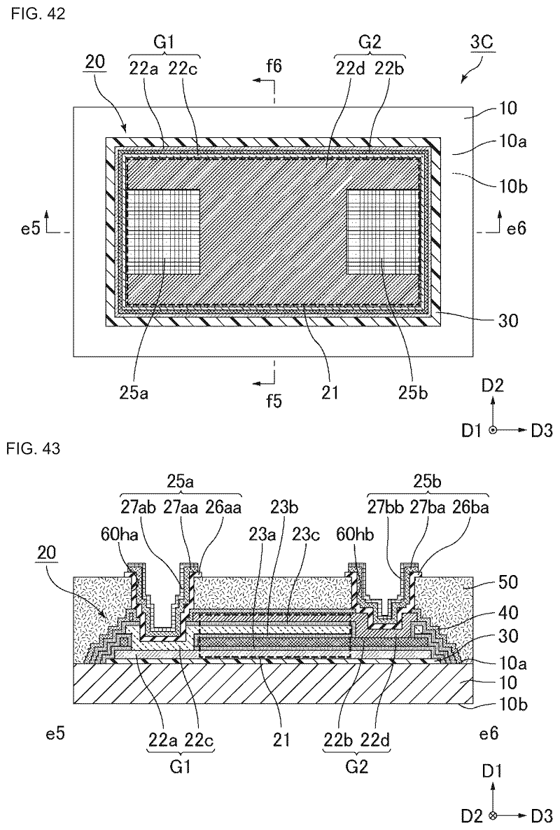

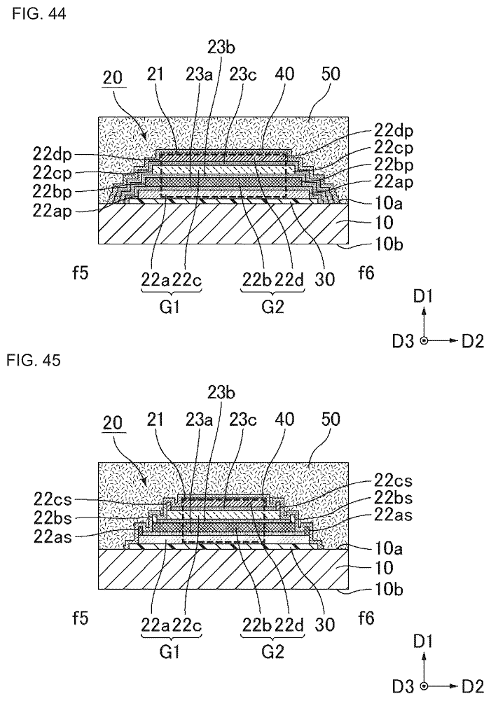

FIG. 42 is a schematic plan view depicting still another example of the passive electronic component of embodiment 3 of the present disclosure. FIG. 43 is a schematic cross-sectional view depicting an example of a cross section taken along line e5-e6 of the passive electronic component depicted in FIG. 42. FIG. 44 is a schematic cross-sectional view depicting an example of a cross section taken along line f5-f6 of the passive electronic component depicted in FIG. 42 (excluding the first outer electrode).

Also, in a passive electronic component 3C depicted in FIGS. 42, 43, and 44, the capacitance forming portion 21 has four inner electrode layers, similarly to the passive electronic component 3B.

In the passive electronic component 3C, the capacitance forming portion 21 is disposed in substantially the entire region in the second direction D2 and the third direction D3 (excluding regions overlapping the first outer electrode 25a and the second outer electrode 25b) when the capacitor 20 is viewed in plan view from the first direction D1. In the passive electronic component 3C, compared with the passive electronic component 3B, the area of the inner electrode layers in the capacitance forming portion 21 when the capacitor 20 is viewed in plan view from the first direction D1 is large, and thus the electrostatic capacity of the capacitance forming portion 21 is high.

FIG. 45 is a schematic cross-sectional view depicting another example of the cross section taken along line f5-f6 of the passive electronic component depicted in FIG. 42 (excluding the first outer electrode).

Also in the example depicted in FIG. 45, similarly to the example depicted in FIG. 41, at least one of the inner electrode layers of the first group G1 is provided with a protrusion that protrudes in the first direction D1 from portions on both end portion sides in the second direction D2. Further, also in the example depicted in FIG. 45, similarly to the example depicted in FIG. 41, the protrusion contains the same material as the inner electrode layer of the second group G2 adjacent, on the side opposite to the substrate 10, to the inner electrode layer of the first group G1 provided with the protrusion.

Also, in the example depicted in FIG. 45, similarly to the example depicted in FIG. 41, at least one of the inner electrode layers of the second group G2 is provided with a protrusion that protrudes in the first direction D1 from portions on both end portion sides in the second direction D2. Further, also in the example depicted in FIG. 45, similarly to the example depicted in FIG. 41, the protrusion contains the same material as the inner electrode layer of the first group G1 adjacent, on the side opposite to the substrate 10, to the inner electrode layer of the second group G2 provided with the protrusion.

Although FIGS. 41 and 45 depict, as an example, the case where the inner electrode layer is provided with the protrusion in the third aspect of the passive electronic component of the present disclosure, the inner electrode layer may be provided with the protrusion in the first aspect of the passive electronic component of the present disclosure, or the inner electrode layer may be provided with the protrusion in the second aspect of the passive electronic component of the present disclosure.

### REFERENCE SIGNS LIST

1A, 1B, 1C, 2A, 2B, 2C, 3A, 3B, 3C passive electronic components
10 substrate
10a first main surface of the substrate
10b second main surface of the substrate
20 capacitor
21 capacitance forming portion
22a first inner electrode layer
22ap end portion of the first inner electrode layer in a second direction
22as protrusion of the first inner electrode layer
22b second inner electrode layer
22bp end portion of the second inner electrode layer in the second direction
22bs protrusion of the second inner electrode layer
22c third inner electrode layer
22cp end portion of the third inner electrode layer in the second direction
22cs protrusion of the third inner electrode layer
22d fourth inner electrode layer
22dp end portion of the fourth inner electrode layer in the second direction
22e fifth inner electrode layer
22ep end portion of the fifth inner electrode layer in the second direction
23a first dielectric layer
23b second dielectric layer
23c third dielectric layer
23d fourth dielectric layer
25a first outer electrode
25b second outer electrode
26, 26aa, 26ba seed layers
27aa, 27ba first plated layers
27ab, 27bb second plated layers
30 insulating layer
40 moisture-resistant protective layer
50 resin protective layer
23ah, 23bha, 23bhb, 23cha, 23chb, 23dha, 23dhb, 40ha, 40hb, 50ha, 50hb, 60ha, 60hb through-holes
D1 first direction
D2 second direction
D3 third direction
G1 first group
G2 second group

1. A passive electronic component comprising:
a substrate having a first main surface and a second main surface opposed to each other in a first direction; and
a capacitor on a first main surface side of the substrate, wherein
the capacitor has a capacitance forming portion in which inner electrode layers and dielectric layers are alternately laminated in the first direction,
the capacitance forming portion has three or more of the inner electrode layers, and
wherein
when all of the three or more of the inner electrode layers are counted in order from a substrate side in the first direction, a first group to which the inner electrode layers located at odd-numbered positions and a second group to which the inner electrode layers located at even-numbered positions are defined,
when all of the three or more of the inner electrode layers are counted in order from the substrate side in the first direction, with N being an odd number of three or more, an Nth inner electrode layer that is located at an Nth position and belongs to the first group and an (N-1)th inner electrode layer that is located at an (N-1)th position and belongs to the second group are defined, and
in plan view from the first direction, a second direction perpendicular to an average direction of a current flowing through the capacitance forming portion when a voltage is applied to the capacitance forming portion is defined,
in a cross section taken along the first direction and the second direction, opposed end portions of the Nth inner electrode layer of the first group in the second direction are located on an outer side in the second direction relative to opposed end portions of the (N-1)th inner electrode layer of the second group in the second direction.

2. The passive electronic component according to claim 1, wherein in the cross section, the Nth inner electrode layer of the first group covers, in the second direction, on opposed end portion sides in the second direction, at least part of respective side surfaces of the (N-1)th inner electrode layer of the second group on the opposed end portion sides in the second direction.

3. The passive electronic component according to claim 1, wherein
when all of the three or more of the inner electrode layers are counted in order from the substrate side in the first direction, an (N-2)th inner electrode layer that is located at an (N-2)th position and belongs to the first group is defined,
in the cross section, the Nth inner electrode layer and the (N-2)th inner electrode layer of the first group are connected to each other on the opposed end portion sides in the second direction.

4. The passive electronic component according to claim 1, wherein
when, in the plan view from the first direction, a second direction perpendicular to an average direction of a current flowing through the capacitance forming portion when a voltage is applied to the capacitance forming portion is defined,
at least one of the inner electrode layers of the first group includes a protrusion that protrudes in the first direction from portions on opposed end portion sides in the second direction, and
the protrusion contains a same material as the inner electrode layer of the second group adjacent to the inner electrode layer of the first group having the protrusion on a side opposite to the substrate.

5. The passive electronic component according to claim 1, wherein
when, in the plan view from the first direction, a second direction perpendicular to an average direction of a current flowing through the capacitance forming portion when a voltage is applied to the capacitance forming portion is defined,
at least one of the inner electrode layers of the second group includes a protrusion that protrudes in the first direction from portions on opposed end portion sides in the second direction, and
the protrusion contains a same material as the inner electrode layer of the first group adjacent to the inner electrode layer of the second group having the protrusion on a side opposite to the substrate.

6. The passive electronic component according to claim 1, wherein the capacitor further includes a first outer electrode electrically connected to all the inner electrode layers of the first group.

7. The passive electronic component according to claim 6, wherein the capacitor further includes a second outer electrode electrically connected to all the inner electrode layers of the second group.

8. The passive electronic component according to claim 1, further comprising:
an insulating layer between the substrate and the capacitor in the first direction.

9. The passive electronic component according to claim 1, further comprising:
a moisture-resistant protective layer that covers the capacitance forming portion.

10. The passive electronic component according to claim 1, further comprising:
a resin protective layer that covers the substrate and the capacitance forming portion.

11. A passive electronic component comprising:
a substrate having a first main surface and a second main surface opposed to each other in a first direction; and
a capacitor on a first main surface side of the substrate, wherein
the capacitor has a capacitance forming portion in which inner electrode layers and dielectric layers are alternately laminated in the first direction,
the capacitance forming portion has four or more of the inner electrode layers, and
wherein
when all of the four or more of the inner electrode layers are counted in order from a substrate side in the first direction, a first group to which the inner electrode layers located at odd-numbered positions belong and a second group to which the inner electrode layers located at even-numbered positions belong are defined,
when all of the four or more of the inner electrode layers are counted in order from the substrate side in the first direction, with N being an even number of four or more, an Nth inner electrode layer that is located at an Nth position and belongs to the second group and an (N-1)th inner electrode layer that is located at an (N-1)th position and belongs to the first group are defined, and
in plan view from the first direction, a second direction perpendicular to an average direction of a current flowing through the capacitance forming portion when a voltage is applied to the capacitance forming portion is defined,
in a cross section taken along the first direction and the second direction, opposed end portions of the Nth inner electrode layer of the second group in the second direction are located on an outer side in the second direction relative to opposed end portions of the (N-1)th inner electrode layer of the first group in the second direction.

12. The passive electronic component according to claim 11, wherein in the cross section, the Nth inner electrode layer of the second group covers, in the second direction, on opposed end portion sides in the second direction, at least part of respective side surfaces of the (N-1)th inner electrode layer of the first group on opposed end portion sides in the second direction.

13. The passive electronic component according to claim 11, wherein
when all four or more of the inner electrode layers are counted in order from the substrate side in the first direction, an (N-2)th inner electrode layer that is located at an (N-2)th position and belongs to the second group is defined,
in the cross section, the Nth inner electrode layer and the (N-2)th inner electrode layer of the second group are connected to each other on the opposed end portion sides in the second direction.

14. The passive electronic component according to claim 11, wherein
when, in the plan view from the first direction, a second direction perpendicular to an average direction of a current flowing through the capacitance forming portion when a voltage is applied to the capacitance forming portion is defined,
at least one of the inner electrode layers of the first group includes a protrusion that protrudes in the first direction from portions on opposed end portion sides in the second direction, and
the protrusion contains a same material as the inner electrode layer of the second group adjacent to the inner electrode layer of the first group having the protrusion on a side opposite to the substrate.

15. The passive electronic component according to claim 11, wherein
when, in the plan view from the first direction, a second direction perpendicular to an average direction of a current flowing through the capacitance forming portion when a voltage is applied to the capacitance forming portion is defined,
at least one of the inner electrode layers of the second group includes a protrusion that protrudes in the first direction from portions on opposed end portion sides in the second direction, and
the protrusion contains a same material as the inner electrode layer of the first group adjacent to the inner electrode layer of the second group having the protrusion on a side opposite to the substrate.

16. The passive electronic component according to claim 11, further comprising:
an insulating layer between the substrate and the capacitor in the first direction.

17. The passive electronic component according to claim 11, further comprising:
a moisture-resistant protective layer that covers the capacitance forming portion.

18. A passive electronic component comprising:
a substrate having a first main surface and a second main surface opposed to each other in a first direction; and
a capacitor on a first main surface side of the substrate, wherein
the capacitor has a capacitance forming portion in which inner electrode layers and dielectric layers are alternately laminated in the first direction,
the capacitance forming portion has three or more of the inner electrode layers,
when all of the three or more of the inner electrode layers are counted in order from a substrate side in the first direction, a first group to which the inner electrode layers located at odd-numbered positions belong and a second group to which the inner electrode layers located at even-numbered positions belong are defined, and
in plan view from the first direction, peripheral edges of all of the inner electrode layers of the second group are located on an inner side relative to a peripheral edge of a first inner electrode layer located closest to the substrate in the first group.

19. The passive electronic component according to claim 18, wherein
when, in the plan view from the first direction, a second direction perpendicular to an average direction of a current flowing through the capacitance forming portion when a voltage is applied to the capacitance forming portion is defined,
at least one of the inner electrode layers of the first group includes a protrusion that protrudes in the first direction from portions on opposed end portion sides in the second direction, and
the protrusion contains a same material as the inner electrode layer of the second group adjacent to the inner electrode layer of the first group having the protrusion on a side opposite to the substrate.

20. The passive electronic component according to claim 18, wherein
when, in the plan view from the first direction, a second direction perpendicular to an average direction of a current flowing through the capacitance forming portion when a voltage is applied to the capacitance forming portion is defined,
at least one of the inner electrode layers of the second group includes a protrusion that protrudes in the first direction from portions on opposed end portion sides in the second direction, and
the protrusion contains a same material as the inner electrode layer of the first group adjacent to the inner electrode layer of the second group having the protrusion on a side opposite to the substrate.
